(19) United States
(12) Patent Application Publication
(10) Pub. No.: US 2017/0181459 A1
(43) Pub. Date: Jun. 29, 2017

(54) BABY FOOD PUREE PROCESS AND APPLICATIONS THEREOF

(71) Applicant: Beech-Nut Nutrition Corporation, Amsterdam, NY (US)

(72) Inventors: Robert Harvey, Amsterdam, NY (US); Christopher Darling, Amsterdam, NY (US)

(73) Assignee: HERO AG, Lenzburg, Switzerland (CH)

(21) Appl. No.: 15/300,246

(22) PCT Filed: Mar. 26, 2015
(86) PCT No.: PCT/US15/22673

§ 371 Date: Sep. 28, 2016

Related U.S. Application Data
(60) Provisional application No. 61/972,340, filed on Mar. 30, 2014.

(51) Int. Cl. A23L 19/10; A23L 19/00

(52) U.S. Cl. CPC A23L 19/105; A23L 19/09; A23V 2002/00

(57) ABSTRACT

Disclosed are methods for making a baby food purée, such as a sweet potato purée, by employing a recipe management system that uses the steps of cold extraction followed immediately by cold deaeration to produce an all-natural baby food purée. The processes disclosed herein eliminate the need for addition of exogenous enzymes, preservatives or anti-oxidants, while further obviating any requirement for blanching vegetable ingredients. Also contained in the present disclosure are methods and systems for generating purees from one or more starting ingredients.

### CROSS-REFERENCE TO RELATED APPLICATIONS

This application claims priority to U.S. Provisional Application No. 61/972,340 filed Mar. 30, 2014, the entire contents of which are hereby incorporated by reference in its entirety.

### FIELD OF THE INVENTION

The present disclosure relates generally to methods for making purees. In particular, the present disclosure includes recipe management systems and processes for making pureed baby food products.

### BACKGROUND OF THE INVENTION

The following description is provided to assist the understanding of the reader. None of the information provided or references cited is admitted to be prior art.

Coterminous with the myriad varieties of known fruits and vegetables are methods for producing consumer goods containing such foodstuffs. For example, sweet potatoes alone account for approximately 6-8,000 different varieties of vegetables, which include wild accessions, farmer varieties, and breeding lines. Baby food products containing sweet potatoes, moreover, constitute a significant portion of food products available to consumers, which likely transpires from the fact that during the first year of life the most commonly consumed vegetables are sweet potatoes, carrots, green beans, and broccoli. See, e.g., Siega-Riz et al., “Food Consumption Patterns of Infants and Toddlers: Where Are We Now?” J. Am. Diet Assoc. 110: S38-S51 (2010). Nevertheless, despite the various methods for preparing sweet potatoes and others vegetable-fruit combinations, a need exists for methods of preparing these foods in the absence of harsh processing techniques, e.g., blanching and/or adding exogenous additives, which can alter the color, flavor and/or the nutrient components of foods subjected to such treatments.

In this regard, U.S. Pat. No. 3,644,129 discloses methods in which potatoes are blanched and then frozen, because it is believed that blanching is necessary to inactivate enzymes, and thus inhibit subsequent discoloration. Similarly, U.S. Pat. No. 4,632,834 details the benefits of sweet potato blanching, albeit to the detriment of flavor and color. To minimize the adverse effects of blanching, the foregoing patent connotes sweet potato blanching at increased temperatures, where such deleterious effects are reconciled by the subsequent application of an orange juice additive. In accord, U.S. Pat. No. 4,579,743 describes a method for preparing surface-treated potatoes, where the surface sugar and starch molecules are cross-linked, water-blanched and soaked in an oxidizing solution with non-reducing sugars and antioxidant preservatives.

Although, U.S. Pat. No. 8,247,017 discusses sweet potato preparation in the absence of blanching, this document nevertheless teaches the importance of adding citric acid as a preservative in addition to employing other natural seasoning ingredients to enhance color and texture. Likewise, a solution containing corn syrup, honey, brown sugar, lemon and vanilla flavors is also sprayed on the sweet potatoes prior to freezing to preserve natural flavors, as discussed in the foregoing patent document.

Accordingly, despite the existence of the vegetable-processing techniques described above, the need remains for a technique of preparing fresh and/or frozen consumer goods, such as, e.g., fruits and vegetables, that maintain their natural characteristics, flavor and color, which nonetheless still possess a long shelf-life. Achieving such a product that is also all-natural, and which has not been subjected to harsh preparation during production, remains a long-felt need in the baby food industry.

### SUMMARY OF THE INVENTION

In one aspect, the present disclosure provides a recipe management process for making a puree, which includes: providing one or more fruit and/or vegetable ingredients selected from fresh, aseptic, individually quick frozen (IQF) drums and IQF totes, or any combination thereof; subjecting the one or more ingredients to cold extraction; subjecting the one or more ingredients to cold deaeration immediately after the cold extraction; heating the ingredients; and refining and/or finishing the ingredients to produce a the puree. In illustrative embodiments, the one or more fruit and/or vegetable ingredients are selected from peaches, pears, apples, plums, carrots, beans, peas, sweet potatoes, squash, mango, pineapple, asparagus, spinach, papaya, guava, sweet corn, pumpkin, blueberries, blackberries, cherries, strawberries, kiwi, aronia berries, raspberries, zucchini, oranges, and beets. In some embodiments, the sweet potatoes are selected from Allgold, Apache, Beauregard, Brinkley White, Bunch, Carolina Ruby, Centennial, Cherokee, Continental Red, Cordner, Cordner's Red, Covington variety, Dianne, Garnet, Georgia Jet, Hayman, Hernandez, Jewell, Porto Rico and White Delight sweet potatoes, or any combination thereof

In illustrative embodiments, the sweet potatoes are peeled IQF sweet potatoes. In suitable embodiments, the peeled IQF sweet potatoes are unblanched. In illustrative embodiments, the unblanched peeled IQF sweet potatoes are diced prior to the cold extraction. In some embodiments, heating is not required prior to enzyme inactivation. In certain embodiments, the heating is sufficient to sequentially activate and then inactivate endogenous enzymatic activity. In illustrative embodiments, the refining and/or finishing is selected from centrifuging, clarifying, decanting, packing, drying, bottling and canning, or any combination thereof. In illustrative embodiments, the process does not require or contain any exogenous and/or non-native enzymes. In some embodiments, the exogenous and/or non-native enzymes are one or more recombinant amylase enzymes or reconstituted native amylase enzymes, or both.

In suitable embodiments, starch is converted to sugar by enzymatic catalysis from native enzymes. In illustrative embodiments, the native enzymes comprise one or more amylase enzymes. In some embodiments, the one or more fruit and/or vegetable ingredients are peeled prior to the cold extraction. In illustrative embodiments, the peeling is steam peeling, abrasive peeling or lye peeling, or any combination thereof. In illustrative embodiments, the peeling, cold extraction or cold deaeration steps, or any combination thereof, eliminate any detectable polyphenol oxidase activity. In certain embodiments, the puree is not discolored due to the polyphenol oxidase activity. In some embodiments, hot deaeration refinement is optionally performed. In illustrative embodiments, the one or more fruit and/or vegetable ingredients are added to an extractor at defined recipe ratios.

In some embodiments, the one or more fruit and/or vegetable ingredients are added to an extractor at one or more separate infeed ports. In illustrative embodiments, the one or more fruit and/or vegetable ingredients are raw and/or frozen. In some embodiments, the one or more fruit and/or vegetable ingredients are diced, chunked, chopped, turbo chopped, crushed, raw, extruded, cut, mashed, pureed, or blended, or any combination thereof, prior to the cold extraction. In illustrative embodiments, the one or more fruit and/or vegetable ingredients are partially or completely thawed prior to or during the cold extraction. In some embodiments, one or more screw loader cells meter the one or more fruit and/or vegetable ingredients prior to the cold extraction.

In illustrative embodiments, one or more fruit and/or vegetable ingredients are blended into a single puree. In certain embodiments, water, ascorbic acid and citric acid are not added to the one or more fruit and/or vegetable ingredients. In some embodiments, water, ascorbic acid and citric acid are not added to the puree. In illustrative embodiments, pulp is separated from an ingredient waste stream. In suitable embodiments, the final puree is an all-natural baby food puree.

In one aspect, the present disclosure provides a recipe management system for making a sweet potato puree, which includes: drums and/or totes of unblanched individually quick-frozen (IQF) sweet potatoes; an extraction device capable of cold extraction, wherein the sweet potatoes are subjected to the cold extraction; a deaeration device capable of cold deaeration, wherein the sweet potatoes are subjected to the cold deaeration immediately after the cold extraction; a thermal processing compartment for sequentially activating and inhibiting enzymatic catalysis within the deaerated puree; and refinement or finishing of the sweet potatoes to produce the sweet potato puree. In illustrative embodiments, the sweet potatoes are inspected, peeled and/or sorted prior to the cold extraction. In some embodiments, the cold extraction comprises thermal pulsing of the sweet potatoes. In illustrative embodiments, the sweet potatoes are peeled and diced prior to the cold extraction.

In suitable embodiments, heating is not required other than for enzymatic activation and subsequent inactivation after the cold deaeration step. In illustrative embodiments, the refinement or finishing is selected from centrifuging, clarifying, decanting, packing, drying, bottling and canning, or any combination thereof. In some embodiments, the system further includes the absence of any exogenous and/or non-native enzymes. In illustrative embodiments, the exogenous and/or non-native enzymes comprise amylase enzymes. In some embodiments, starch is converted to sugar by enzymatic catalysis from native enzymes. In certain embodiments, the native enzymes comprise one or more amylase enzymes. In illustrative embodiments, the sweet potatoes are selected from Allgold, Apache, Beauregard, Brinkley White, Bunch, Carolina Ruby, Centennial, Cherokee, Continental Red, Cordner, Cordner's Red, Covington variety, Dianne, Garnet, Georgia Jet, Hayman, Hernandez, Jewell, Porto Rico and White Delight sweet potatoes, or any combination thereof.

In illustrative embodiments, the peeling is steam peeling, abrasive peeling or lye peeling, or any combination thereof. In some embodiments, the peeling, cold extraction or cold deaeration steps, or any combination thereof, eliminate any detectable polyphenol oxidase activity. In certain embodiments, the puree is not discolored due to the polyphenol oxidase activity. In illustrative embodiments, hot deaeration refinement is performed. In illustrative embodiments, the sweet potatoes are raw and/or frozen.

In some embodiments, the sweet potatoes are diced, chunked, chopped, turbo chopped, crushed, raw, extruded, cut, mashed, pureed, or blended, or any combination thereof, prior to the cold extraction. In illustrative embodiments, the sweet potatoes are partially or completely thawed prior to the cold extraction. In suitable embodiments, one or more screw loader cells meter the sweet potatoes prior to the cold extraction. In illustrative embodiments, the sweet potatoes are blended into a single puree. In some embodiments, water, ascorbic acid and citric acid are not added to the sweet potatoes. In suitable embodiments, pulp is separated from an ingredient waste stream. In illustrative embodiments, the final product is an all-natural baby food puree.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE FIGURES

FIG. 1 shows fruit compositions resulting from the present methods. FIG. 1A shows an apple puree, produced from Ginger Gold apples, prior to and after cold extraction, cold deaeration and enzymatic inactivation. FIG. 1B shows the same apple compositions after two-hours at room temperature (RT).

FIG. 2 is a diagrammatic representation of the methods disclosed herein, where the initial stages of infeed, cold extraction, cold deaeration and enzymatic inactivation are detailed.

FIG. 3 is a diagrammatic representation of the methods disclosed herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Disclosed herein are methods for producing fruit and vegetable purees, particularly sweet potato purees. Further disclosed herein are methods, steps, and reactions for the commercial production of baby food purees using systems and steps which impart an improved process for expedient production of baby food purees. The definitions of certain terms as used in this specification are provided below. Unless defined otherwise, all technical and scientific terms used herein generally have the same meaning as commonly understood by one of ordinary skill in the art to which this invention belongs.

As used herein, unless otherwise stated, the singular forms “a,” “an,” and “the” include plural reference. Thus, for example, a reference to “a vegetable” or “the vegetable” includes a plurality of vegetables.

As used herein, the term “about” will be understood by persons of ordinary skill in the art and will vary to some extent depending upon the context in which it is used. If there are uses of the term which are not clear to persons of ordinary skill in the art, given the context in which it is used, the term “about” in reference to quantitative values will mean up to plus or minus 10% of the enumerated value.

As used herein, the term “aggregation” refers to a process whereby biomolecules, such as polysaccharides, or polypeptides stably associate with each other to form a multimeric, insoluble complex, which does not disassociate under physiological conditions unless a disaggregation step is performed.

As described herein, the term “blanching” is understood to mean the initial step of thermal treatment of whole fruits and/or vegetables, which is generally performed using steam or hot water for example and intended to block enzymatic activity and microbial growth. For example, EP111590 and EP124627 discuss blanching techniques and are hereby incorporated by reference in their entirety. See also, Malomo “Effect of Blanching and Unblanching on Rheological Properties of Sweet-Potato Bread,” SAVAP International; Vol. 4, No. 3, pp. 24-47 (2013).

As described herein, the term “Brix relative density”, “Brix”, or “°Bx”, refers to a well-known hydrometer scale for measuring the sugar content of a solution at a given temperature. Thus, the unit °Bx, refers to a measure of the solubilized sugars in solution. The Brix scale measures the number of grams of sugar present per 100 grams of aqueous sugar solution (the total solubilized solid content). For example, a measurement of 10°Bx refers to 10 mg/ml of sugar in solution.

As used herein, the term “carbohydrates” will be understood by one skilled in the art to include polyhydroxy-aldehydes or -ketones and compounds derived therefrom. Carbohydrates can include compounds composed of at least one basic monosaccharide unit. They may be classified as simple carbohydrates and complex carbohydrates. Simple carbohydrates are monosaccharides and disaccharides. Complex carbohydrates are polysaccharides, or large molecules composed of straight or branched chains of monosaccharides.

As used herein, the terms “flavor”, “fresh flavor” and “raw flavor” are used interchangeably and refer to the taste and/or the flavor of a puree according to the present invention which is similar or identical to that of an uncooked puree derived from unblanched vegetables or fruit purees.

As used herein, “frozen sweet potatoes” refers to sweet potatoes frozen for any amount of time at any temperature. Frozen sweet potatoes include, without limitation, sweet potatoes frozen at a temperature of −90° F. or below, and/or frozen for at least five minutes. Preferably, frozen sweet potatoes are prepared according to IQF procedures well known in the art. See, e.g., Salunkhe et al., “Storage, Processing and Nutritional Quality of Fruits and Vegetables,” 2nd Ed., Vol. 2 of Processed Fruits and Vegetables, CRC Press, Ch. 4 (1991); and Hanson, L. P., “Commercial Processing of Foods,” Food Technology Review No. 27, NDC, pp. 55-6, (1975). Likewise, the term “sweet potatoes,” as used herein, includes, but is not limited to yams, orange sweet potatoes, sweet potato varieties, such as, for example, Allgold, Apache, Beauregard, Brinkley White, Bunch, Carolina Ruby, Centennial, Cherokee, Continental Red, Cordner, Cordner's Red, Covington variety, Dianne, Garnet, Georgia Jet, Hayman, Hernandez, Jewell, Porto Rico and White Delight sweet potatoes, and white sweet potatoes, which refers to tubers of light colored flesh of the species Ipomoea batata, of the morning glory family, Convolvulaceae, and are known in the patent art. See, e.g., U.S. Pat. No. 4,925,697 entitled “Process for Products from Sweet Potatoes,” U.S. Pat. No. 5,204,133 entitled “Process for Products from Sweet Potatoes,” and U.S. Pat. No. 5,244,689 entitled “Flour, Bread, Milk and Other Products from White Sweet Potatoes, Cassava, Edible Aroids, Amaranth, Yams and Lotus.”

As used herein, the term “fruit” refers to produce obtained from plants associated with seeds, which include, but are not limited to, apples, apricots, bananas, blueberries, cherries, clementines, cress, elderberries, grapes, grapefruit, lemons, mangos, oranges, papaya, peaches, pears, pineapples, plums, raspberries, rhubarb, sorrel, strawberries, and combinations thereof.

As used herein, the term “infant” or “baby” refers to a child in the first period of life generally considered to be in the age range of from birth to about four years.

As used herein, the term “linkage” or “linkages” refers to the number of the carbon moiety to which a glucose or other molecule is attached. The α (alpha) and β (beta) prefixes denote whether the linkage is axial or equatorial to the carbon ring, respectively. Accordingly, alpha linkages are equatorial to the ring and beta linkages are axial.

As used herein, the term “liquefaction reaction” refers to an enzymatic or chemical reaction that reduces the viscosity and/or increases the fluidity of one or more carbohydrates in a mixture.

As used herein, a “maltogenic enzyme” refers to an enzyme that catalyzes the production of maltose from a larger carbohydrate polymer. A maltogenic enzyme can be one of many α-amylases or other amylases. A maltogenic reaction produces maltose, although such a reaction is not mutually exclusive with the production of other saccharides.

As used herein, a “preservative” or “preservatives” refer to an agent that preserves, protects, retains, or promotes the flavor, color, texture, cell wall structure, appearance, moisture, or other desirable characteristic of processed fruit or vegetable products. The use of preservatives, however, precludes the production of an “all-natural” product.

As used herein, “processed” fruits or vegetable products, refers to any variety of fruit or vegetable as well as any combinations thereof, which may be any of whole or cut, pitted, cored, dehydrated, frozen, stoned and/or peeled, with inedible parts removed (seeds, pits, stones, etc.) and which have undergone cooking, pressure cooking, or general heating above about 90-120° F. The term “processed” may also include fruit or vegetable products that have been coated, filled, contacted with at least one additive, including a flavoring agent, a sweetening agent, a preservative and/or are packaged in a processed manner.

As used herein, “puree” refers to the pulp of a product that has been crushed or homogenized in a substantially smooth and/or creamy condition, without a substantial amount of conglomerated pulp constituents as fragments or pieces. Purees of the present invention are obtained using the disclosed processes and systems, which produce a puree stream separate from a waste matter stream. Puree, when used as a verb, shall include, without limitation, to rub through a strainer or process in a blender. When used as a noun, “puree” shall include, without limitation, food prepared by straining, stirring or blending. The term “puree” may also designate slurries, mousselines, compotes and vegetable creams.

As used herein, “shelf-life stable” or “shelf-stable” refers to a baby-food composition, that can be stored un-refrigerated on the shelf for a period of time and remain suitable for consumption. Shelf-stable foods are processed and packaged in a manner such that microorganisms are inhibited from growing in the product at non-refrigerated temperatures of storage over 41° F. for extended periods of time.

As used herein, a duration “sufficient” to permit one or more amylase enzymes to catalyze the breakdown of starches present in an ingredient mixture to maltose, glucose, sucrose, fructose and/or other sugars depends on the specific conditions employed. Suitable durations include, without limitation, 30±5 min. In some embodiments, the duration is approximately 5-10 min.

As used herein, a “suitable temperature” for pureeing ranges from, without limitation, about 100-190° F.±10° F. In suitable embodiments, a suitable temperature is about 150° F.±10° F.

As used herein, a temperature and duration sufficient to inactivate native enzymes include, for example, at least about 205° F.±10° F. for about from 1-5 minutes or longer.

As used herein, “total solids” or “solids” refer to the carbohydrate and cellulose contents of a fruit and/or vegetable puree, most of which is insoluble.

As used herein, the term “vegetable” refers to produce obtained from vegetable plants which include, but are not limited to, members of the buckwheat family including buckwheat, rhubarb and sorrel; members of the Goosefoot family including beets, spinach and Swiss chard; members of the Gourd family including cantaloupe, casaba, cucumber, honeydew, pumpkin, summer squash, winter squash and watermelon; members of the grass family including barley, corn, hominy millet, oat, rice, rye, sorghum, sugar cane and wheat; members of the lily family including aloe, asparagus, chives, garlic, leek, onion, sarsaparilla and shallot; members of the mallow family including cottonseed, marshmallow and okra; members of the morning glory family including sweet potato; members of the mustard family including broccoli, brussel sprouts, cabbage, cauliflower, collards, garden cress, horseradish, kale, kohlrabi, mustard, radish, rutabaga, turnip and watercress; members of the nightshade family including bell pepper, cayenne pepper, paprika, eggplant, white potato and tomato; members of the parsley family including anise, caraway, carrot, celeriac, celery, coriander, dill, fennel, parsley and parsnip; and members of the pea or legume family including acacia, alfalfa, black-eyed pea, broad bean, carob bean, chick pea or garbanzo, common beans, green beans, lentil, licorice, lima bean, mesquite, pea, peanut, tamarind and tragacanth.

Other vegetables and fruits that are within the scope of the present invention include, but are not limited to apples, pears, Asian pears, cherries, strawberries, plums, peaches, nectarines, grapes, melons (including watermelon, cantaloupe, honey dew melon, muskmelon, etc.), guava, dates, figs, apricots, kiwi, citrus fruit (including lemons, limes, grapefruit, oranges, tangelos, kumquats, ugli fruit, mandarin oranges, Satsuma oranges, etc.), mango, bananas, passion fruit, pineapple, cranberries, blueberries, blackberries, papaya, coconut, jackfruit, tomatoes, leafy vegetables (also called potherbs, greens, or leafy greens and include lettuce, spinach, Swiss chard, clover, grasses such as wheat, barley and alfalfa), stem vegetables (including asparagus), root vegetables (including tuberous roots, taproots, tubers, rhizomes, corms, and bulbs); some examples of true root vegetables include celeriac, burdock or gobo, arracacha, beet and mangelwurzel, rutabaga, turnip, black cumin, carrot, maca, jicama and ahipa, parsnip, parsley root, daikon and radish, black salsify, skirret, salsify, earthnut, sweet potato, cassava, manka or chago, breadroot, tipsin, or prairie turnip, yacon, konjac, taro, Chinese water chestnut, enset, katakuri, arrowhead or wapatoo, malanga, cocoyam, tannia, rengarenga, vanilla lily, canna, ti, arrowroot, lotus root, cattail or bulrush, hog potato or groundnut, tigernut or chufa, yarns, ube, day lily, artichoke, artichoke hearts, Jerusalem artichoke or sunchoke, earthnut pea, oca or New Zealand yarn, potato, kembili, dazo, Chinese artichoke or crosne, mashua or anu, ulluco, bulibs (garlic, onion, shallot), mushrooms, quamash, seeds (peas, beans), flowers (broccoli), botanical fruits (cucumbers, squash, pumpkins, capsicums), culinary fruits (nuts, grains, herbs), Brussels sprouts, pumpkins, squash, cabbage, cauliflower, kale, rapini, kai-lan, bok choy, komatsuna, mizuna greens, oriental mustard, amaranth, arugula, bitterleaf, catsear, celtuce, Ceylon spinach, chicory, Chinese mallow, chrysanthemum, corn salad, cress, dandelion, endive, epazote, fat hen, fiddlehead, fluted pumpkin, golden samphire, Good King Henry, Iceplant, Knka, lagos bologi, land cress, Lizard's tail, Melokhia, mustard, New Zealand spinach, orache, radicchio, samphire, sea beet, seakale, Sierra Leone bologi, soko, sorrel, summer purslane, watercress, water spinach, winter purslane, Armenian cucumber, eggplant, avocado, caigua, cayenne pepper, chayote, chile pepper, courgette, globe artichoke, luffa, Malabar gourd, marrow, parwal, snake gourd, sweet corn, tinda, West Indian gherkin, zucchini, black-eyed pea, chickpea, dolichos bean, fava bean, guar, horsegram, lentil, lima bean, moth bean, mung bean, okra, peanut, pigeon pea, rice bean, soybean, cardoon, celery, Florence fennel, kohlrabi, leek, Prussian asparagus, Welsh onion, wild leek, bamboo shoot, ginger, rutabaga, chokeberry, hawthorn, serviceberry, loquat, medlar, quince, rowan, rose-hip, shipova, apricot, cherry, plum, peach, nectarine, blackberry, boysenberry, loganberry, cloudberry, wineberry, salmonberry, thimbleberry, bearberry, bilberry, crowberry, huckleberry, lingonberry, barberry, currant, elderberry, gooseberry, hackberry, mayapple, Oregon grape, wolfberry, mulberry, arhat, che, k-pong, persimmon, sageretia, cocoplum, pawpaw, Saw Palmetto, Toyon, dragonfruit, prickly pear, Saguaro, date, fig, olive, pomelo, citron, lemon, limes, avocado, tamarillo, banana, bael, babco, akee and guarana, and combinations thereof.

### Introduction and Overview

Many fruits and vegetables, including sweet potatoes, are important sources of potassium, fiber, and vitamins such as, e.g., vitamin A and vitamin B6, and consequently function as an important part of an infant's diet. Producing baby food purees, however, traditionally requires the use of fresh fruit and/or vegetable ingredients, which imparts difficulties with respect to processing and storage. Fresh vegetable processing, for example, entails a variety of steps to ensure the aesthetic quality and flavor of the pureed product. In this respect, removing the vegetable skin and any surface blemishes by, e.g., peeling, is an important component for maintaining food quality and appearance. Such peeling also functions to mechanically remove deleterious enzymes that may spoil a puree, while leaving other essential enzymes, such as, e.g., amylase, functionally active. Amylase, in this regard, functions to enzymatically convert native vegetable starches into simple sugars under the appropriate conditions. Thereafter, purees may be processed using various procedures to generate a desired consistency and separate the product from the waste stream, all the while preserving flavor. Typically, fresh fruit or vegetable purees are subsequently subjected to a heating step inasmuch as amylase inactivation is required to curtail excess enzymatic catalysis, which could produce a puree product with unsavory characteristics.

The production process for frozen fruits and vegetables also has its complications. While starting with frozen ingredients (and/or freezing a pureed product) eliminates many issues associated with handling fresh produce, subjecting fruits or vegetables to freezing temperatures also inactivates enzyme native to the ingredients, e.g., natural amylase enzymes. Likewise, because blanching is typically required to produce a puree that is enzymatically inert—obviating enzyme activity during storage—enzyme reconstitution is typically required when processing frozen produce. Notwithstanding the undesired prospect of having to refine a puree with recombinant enzymes for carbohydrate catalysis, a puree made from frozen ingredients can produce strong aromas or flavors uncharacteristic of the fruit or vegetable ingredients.

Aseptic purees, moreover, when used as the raw ingredients for baby food purees, can similarly stymie the production process. An aseptic product requiring thermal treatment must be manufactured at a FDA approved processing plant. Furthermore, when using aseptic purees as the starting material for baby food purees, it has been reported that such products tend to possess a darker color and have an overcooked flavor compared to non-aseptic techniques. Reasons for this incongruity likely relate to the fact that the puree product has been thermally processed by both the aseptic supplier and the produce manufacturer. Accordingly, there is a need for new methods of generating fruit and vegetable baby food purees that require minimal handling considerations, while eliminating the need for excess heating and addition of exogenous enzymes.

### General Processing Methods

In one aspect, the present invention involves multiple format processes for metering and blending one or more ingredients from different sources into a single cold extracted puree with a separate product and waste stream. The general feeding and extraction process for frozen fruits and vegetables from individually quick frozen (IQF) drums, IQF totes, and fresh ingredients is provided as follows.

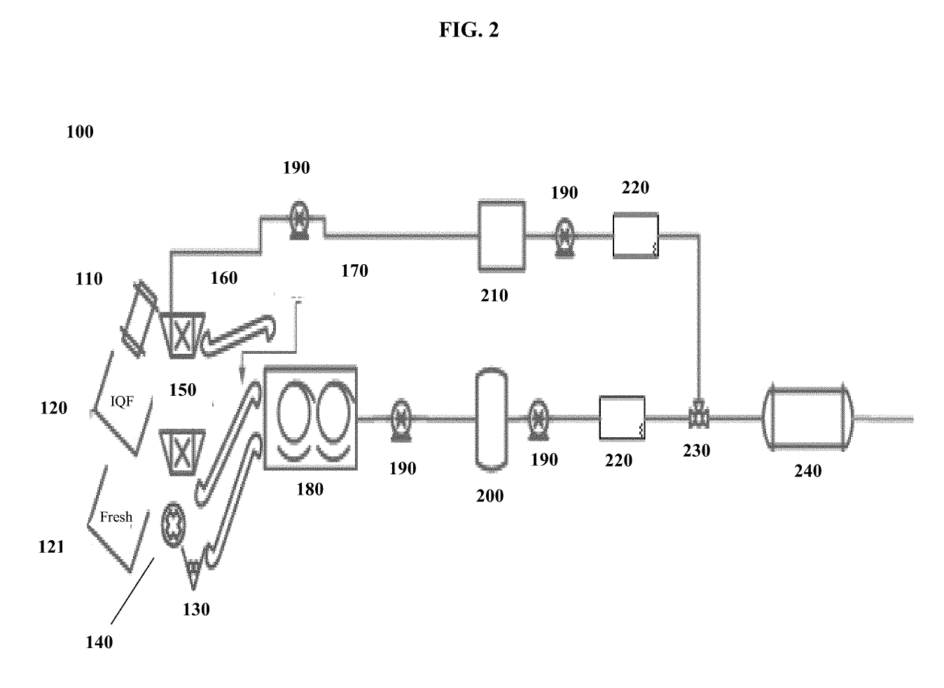

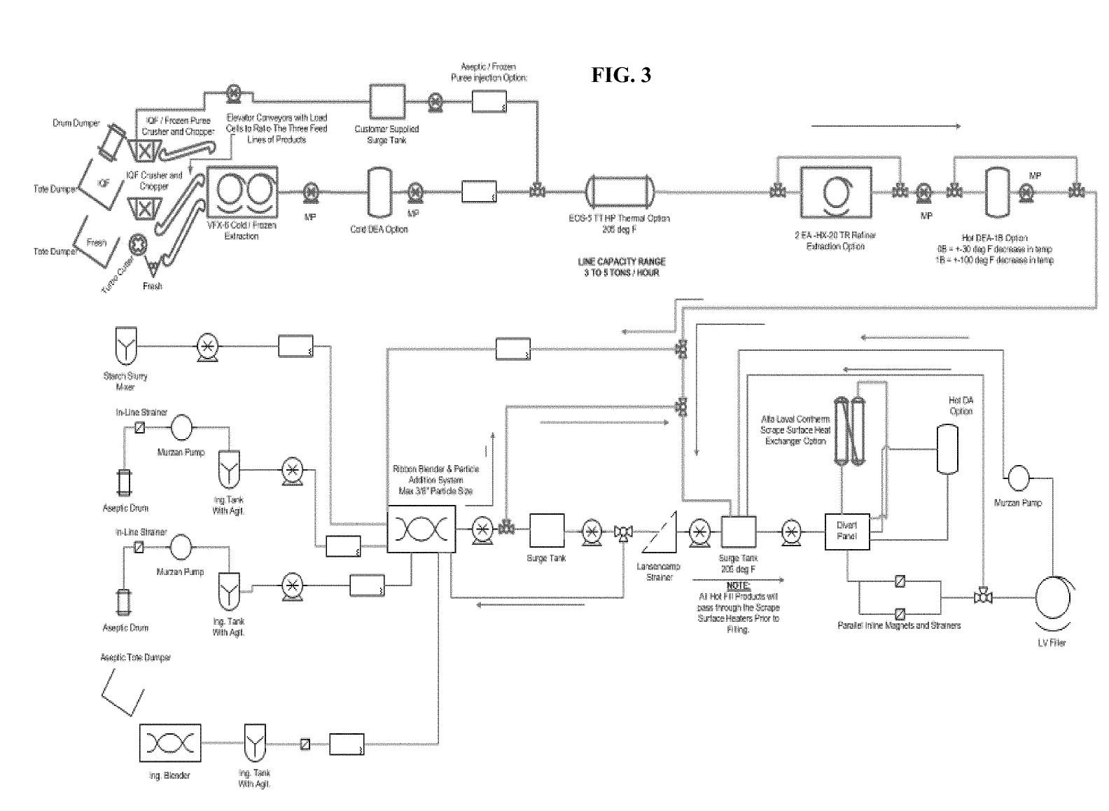

The processes and systems of the present invention employ separate infeed system ports to ultimately arrive at a puree mixture including, but not limited to, fresh, aseptic single strength puree and IQF produce. IQF produce is prepared according to procedures well known in the art. See, e.g., Salunkhe et al., “Storage, Processing and Nutritional Quality of Fruits and Vegetables,” Chapter 4, 2^{nd} Ed., Vol. II (Processed Fruits and Vegetables), CRC Press (1991); and Hanson, L. P., “Commercial Processing of Foods,” Food Technology Review, Vol. 27, pp. 55-56, NDC (1975). In illustrative embodiments, about from 1, 2, 3, 4, 5, 6, 7, 8, 9, 10, 15, or 20 infeed ports to from about 2, 3, 4, 5, 10, 15, 20, 30, 40 or 50 infeed system ports are employed. In suitable embodiments, about from 1, 2 or 3 to from about 3, 4, 5 or 6 infeed system ports are employed. In certain embodiments, 3 or 4 separate infeed system ports are employed. See FIGS. 2-3.

The recipe management systems and processes disclosed herein control the infeed rates of ingredients, which are formatted for the processes and systems of the present invention. In some embodiments the ingredient formats, include, but are not limited to IQF drums, IQF totes, fresh ingredients, and aseptic single strength puree formats. Using either a single or multiplexed format, the present processes and systems impart a puree of 100% fruit, 100% vegetable, or any combination thereof. The constituent steps for implementing the present systems or performing the processes of the present invention include, but are not limited to, one or more of cold extraction, cold deaeration, enzyme deactivation, refinement, finishing, and hot deaeration evaporation. Before discussing, inter alia, the foregoing steps in further detail, a brief description of the apparatuses and devices for performing the processes and systems of the present invention is provided as follows.

In some embodiments, a turbo extractor, e.g., manufactured by Bertocchi, under the model designation VFX, is used to perform the cold extraction steps. See U.S. Pat. No. 4,643,085. Such extractors are provided with different perforated drums or screen meshes, which are selected in accordance with the type of produce, e.g., with respect to what type of manipulation is required, such as, for example, removal of skins, stems, seeds, peels and/or other offal. Other extraction apparatuses are also within the scope of the present invention. See, e.g., U.S. Patent Publication Nos. 2013/0220146; 2012/0037013; 2011/0244101; and 2010/0247728; and U.S. Pat. Nos. 8,367,132; 5,993,876; and 4,643,085; see also Bertocchi apparatus models CX 5, CX 10, CX 12, CX 20, CX 24, CXL 1, CXL 4, CXL 5, CXL 8, CXL 10, CXL 16, CXL 20, CXL 2v, CXL 4v, VCX 1, VCX 3, VCX 6, VCX 12, VCX 16, VCX 24, VCX 32, VCX 3v, VCX 6v, VCX 12v, VCX 16v, VCX 24v, XD 3, XD 5, XD 7, XD 10, XDL 2, XDL 3, XDL 4, XDL 5, XDL 8, VXD 1, VXD 3, VXD 5, VXD 7, VXD 10, VXD 15, XD 3, XD 5, XD 7, XD 10, XDL 2, XDL 3, XDL 4, XDL 5, XDL 8, VXD 1, VXD 3, VXD 5, VXD 7, VXD 10, and VXD 15.

At many stages of the processes and systems described herein, moreover, the puree ingredients are diverted to a mixer for amalgamation by employing a mono-pump, such as a Moyna Model PP1134C, SP1021C or a Waukesha Model U220 pump, and the like. Such mixers include, for example, but are not limited to, Kenics static mixer Model 4 KMR-SAN 6. Other apparatuses necessary or convenient for performing the processes and systems of the present invention are described below in accordance with their intended uses.

Turning to the processing of fresh produce, one or more fresh fruit and/or vegetable ingredients are initially washed, dumped into a hopper and subsequently loaded on an inspection belt for removal of any damaged ingredients in illustrative embodiments. The ingredients are then transferred to a turbo chopper for cutting, chopping, chunking, etc., for resolving the ingredients to a preferred size, shape and/or consistency as appropriate for any particular application in illustrative embodiments. Thereafter, the mechanically converted mixture is metered per a chosen recipe format, which may call for various ratios of the one or more initial ingredients. In illustrative embodiments, the metering is performed via metering screws and load cells. Subsequently, the measured ingredients are directed to an extractor for cold extraction, cold deaeration and puree production.

In suitable embodiments of the present invention, some of the fruit and/or vegetable combinations include one or more of the following ingredients, which can be combined depending on any particular receipt formulation: Sweet Potatoes, Apples, Pears, Black Pepper, Celery Powder, Frozen Squash Puree, IQF Black Beans, IQF Green Peppers, Rolled Oats, IQF Broccoli, IQF Strawberries, Dry Quinoa, Fresh Bartlett Pears, Fresh Butternut Squash, Fresh, Frozen and/or IQF Sweet Potatoes, Cinnamon, Frozen Raspberry Puree, IQF Blueberries, IQF Butternut Squash, IQF Zucchini, Onion Flakes, IQF Black Cherry, Water, IQF Peas, IQF Green Beans, Heavy Cream, Fresh Apple, IQF Carrots, Barley Flakes, Raisin Paste, Lemon Juice Concentrate, Paprika, Frozen Spinach Puree, IQF Aroniaberries, IQF Asparagus, IQF Beets, IQF Blackberries, IQF Cranberries, IQF Kiwis, IQF Oranges, IQF Mandarin Oranges, Chia Seed, IQF Pineapples, IQF Pomegranate Arils, Aseptic Mango Puree SS, Dry Amaranth, Fresh Honey Crisp Apples, Frozen Asparagus Puree, Frozen Avocado Puree, Frozen Banana Puree, and/or Frozen Pumpkin Puree.

Individually quick frozen (IQF) drum and tote system ingredients are processed in a similar fashion as noted above, albeit with the distinction that these ingredient starting materials are crushed in a system processor for mechanically compressing and pulping the frozen ingredients into a pumpable puree. See FIGS. 2-3. As known in the art, IQF refers to the flash freezing of food ingredients to decrease decomposition by turning residual moisture into ice, thereby inhibiting the growth of most bacterial species. See, e.g., Salunkhe et al., “Storage, Processing and Nutritional Quality of Fruits and Vegetables,” 2nd Ed., Vol. 2 of Processed Fruits and Vegetables, CRC Press, Ch. 4 (1991); and Hanson, L. P., “Commercial Processing of Foods,” Food Technology Review No. 27, NDC, pp. 55-6, (1975).

Along these lines, IQF produce are typically diced into ⅜ inch units in some embodiments, but the sizes may vary depending on a particular application. Non-IQF, but nevertheless frozen produce refers to frozen fruit or vegetable purees. Typically, the raw materials for both IQF and non-IQF finished product streams entail, but are not necessarily limited to, cleaning, peeling, dicing and/or chopping, with or without blanching, and sorted for defects, as further detailed herein. At this stage, the two product streams diverge, where IQF produce is directed to a blast freezer and then filled into totes, while the frozen puree is diverted to a macerating system, e.g., Bertocchi HX system, to create a puree. The puree is subsequently pasteurized by heating, filled into drums, and blast frozen in some embodiments. The foregoing steps are further detailed herein with respect to the present invention.

Employing a suitable extractor, e.g., a Bertocchi VFX cold extraction apparatus, frozen products are introduced to a malleability compartment where they are subjected to mechanical comminuting, which, for example, resolves the ingredients into fine particles with sizes ranging from about 1, 2, 3, 4, 5, 6, 7, 8, 9, 10, 15, or 20 mm or inches to from about 2, 3, 4, 5, 10, 15, 20, 30, 40 or 50 mm or inches. In suitable embodiments, sizes range about from 1, 2, 3, 4 or 5 mm or inches to from about 7, 8, 9 or 10 mm or inches. In illustrative embodiments, the fine particles are about 6 mm in size. The malleability compartment, in some embodiments, includes a high speed armature that is rotatable with respect to a stator. The ingredients, at this stage, are subjected to pressure or thermal pulses in quick succession via kinetic egress of the frozen product as achieved between the armature and stator, which have interfacing surfaces possessing one or more protrusions, recesses, adherence nodes and/or one or more cylindania.

Because the ingredients may retain their frozen characteristics prior to malleability processing, the resolution process conferred to such ingredients is distinct from processes employed with respect to starting with fresh ingredients. To this end, in concert with cutting blades of an extractor, the rotation and conformation of the armature imparts a frictional force that is transformed into thermal energy, which assists in the partial defrosting of the frozen or partially frozen ingredients. The thermal dynamics ascribed to such thawing is maintained and/or adjusted by altering the rotational speed of the armature-stator complex. In some embodiments, the speed is set at about from 100, 200, 300, 400 or 500 rpm to about from 600, 1000, 2000, 3000, 4000 or 5000 rpm. In suitable embodiments, the speed is set at about from 500 to about 3000 rpm.

Consequently, at this stage, modest heating, e.g., up to about from 30° F. to about 40° F., occurs in some embodiments to facilitate thawing of the ingredients. Based on a particular recipe format, the ingredients are then pumped through a metering device into the cold extraction system, where, in certain multiplexed embodiments, each ingredient is fed into the extractor via a separate infeed port.

Extraction of the ingredients achieves a blended (or singular) mixture based on the input ratio and refining processes, which consequently yields a puree process stream and a waste stream. The viscosity or coarseness of a puree can be controlled, modified or altered by adjusting a screening mechanism designed to generate a desired puree consistency. Likewise, modest heating can be employed at this stage, i.e., should a more refined puree be desired. Notwithstanding the foregoing, the extraction processes of the present invention are directed to cold extraction in illustrative embodiments.

To this end, cold extraction or room temperature extraction, is a process that is performed using a temperature range extending from a minimum conservation temperature of the product as the case may be, which, in any case, is higher than a freezing temperature, to a maximum environment temperature without heating. See, e.g., U.S. Pat. Nos. 8,367,132; 6,368,654; 5,993,876; EP Pat. No. 1751039; and PCT Publication Nos. WO 05/036993 and WO 02/058489. While no heat is added prior to deaeration, as further discussed below, thermal pulses, which heat the fruit and/or vegetable ingredients to from about 10, 20, 30, 40, 50, or 60° F. to about from 30, 40, 50, 60 or 70° F. In some embodiments, the thermal pulses heat the ingredients to about from 30° F. to about 50° F. degrees. In illustrative embodiments, the thermal pulses heat the ingredients to about from 40° F. to about 45° F. degrees. In this respect, the thermal pulsing precludes the frozen ingredients from refreezing after extraction.

In suitable embodiments, cold extraction of fruit and vegetable ingredients is achieved via a cold turbo-extractor and/or a separate malleability compartment, as detailed herein. Regardless of the starting ingredient format, e.g., fresh, frozen, IQF, etc., a product is produced that exits the extractor via a reservoir or tube, which is subsequently—and immediately—directed to a cold deaeration module component of the present system. Such deaerator are known in the art, and include without limitation, for example, Bertocchi apparatus models CX 5, CX 10, CX 12, CX 20, CX 24, CXL 1, CXL 4, CXL 5, CXL 8, CXL 10, CXL 16, CXL 20, CXL 2v, CXL 4v, VCX 1, VCX 3, VCX 6, VCX 12, VCX 16, VCX 24, VCX 32, VCX 3v, VCX 6v, VCX 12v, VCX 16v, VCX 24v, XD 3, XD 5, XD 7, XD 10, XDL 2, XDL 3, XDL 4, XDL 5, XDL 8, VXD 1, VXD 3, VXD 5, VXD 7, VXD 10, VXD 15, XD 3, XD 5, XD 7, XD 10, XDL 2, XDL 3, XDL 4, XDL 5, XDL 8, VXD 1, VXD 3, VXD 5, VXD 7, VXD 10, and VXD 15.

Other devices, such as, for example, microcutters, are within the scope of the present invention, and include, but are not limited to: Stephan microcutter devices such as Microcut Model Nos. MC-10, MC-12, MC-15, MCH-20, MCH-D-60A, MCH-D-90, MC-100D, MCH-D-100-II, MCH-150, MCH-D-150 and MCH-D-180 (A. Stephan u. Siihne GmbH Co. KG Stephanplatz 2 D-31789 Hameln, Germany); Karl Schnell microcutter devices such as Model Nos. FD 225/130, FD225/100, FD-6, FD2/50 and FD 2/70 (Karl Schnell Inc., P.O. Box 49, New London, Wis.); CFS/Wolfking microcutter devices such as the Wolfking Stainless Steel Microcutter Model MC-225 (CFS B.V., P.O. Box 1, 5760 AA BAKEL, Beekakker 11, 5761 ENBAKEL, The Netherlands); Urschell microcutter devices such as the Urschell Comitrol Processors with micro-cut cutting head, Model Nos. MG-1300, MG-1500, MG-1700 and MG-2100 (Urschel Laboratories, Inc., 2503 Calumet Avenue, Valparaiso, Ind.); Panasonic microcutter devices such as Model Nos. MX-897GM and MX-896TM Microcutter Blender with Stainless steel microcutter blades (Matsushita Electric Industrial Co., Ltd, Home Appliances Group, 2-2-8 Hinode-cho, Toyonaka City, Osaka, Japan 5610821); the Hamilton Beach BlendMaster blender (234 Spring Rd., Washington, N.C. 27889); and the like.

The foregoing system components concerning deaeration remove air (including the oxygen) from the introduced ingredients, which therefore impedes oxygen-dependent enzymatic catalysis. In short, the cold extracted product is directly transported from the cold extractor to the cold deaeration apparatus to maintain the inactivity of aerobic enzymes, which consequently permits use of unblanched ingredients as further detailed herein. Here, the extracted product enters at a temperature slightly exceeding the vaporization temperature given by the vacuum in the deaerator. And, because the degree of vacuum pressure, with normal pumps and accessories available on the market, corresponds to product vaporization temperatures exceeding ambient temperature, the incoming product may be heated in some embodiments to ensure that the vaporization temperature threshold, as defined by the degree of vacuum of the tank, is achieved. See, e.g., WO 2002/058489.

Following cold deaeration, the product may be subjected to heat treatment in some embodiments. In this regard, the extracted-deaerated product is heated from the deaeration exit temperature to about from 100, 115, 130, 140, 160, 180 or 200° F. to about from 170, 180, 200, 220 or 230° F. In some embodiments, the temperature is about 200° F. to about 210° F. degrees. In illustrative embodiments, the temperature is about 205° F. Such rapid heating of the puree inactivates enzymes, which would otherwise be deleterious to puree quality. The unfinished puree is then pumped through an optional refining stage or hot deaeration stage depending on the desired final product.

To this end, the extracted product is directed to a finisher to achieve the desired texture and consistency in certain embodiments. Such finishers are within the scope of the present invention inasmuch as they provide a variety of perforated drums and/or screen sizes to refine purees as desired. In suitable embodiments, the puree is subsequently transported from the finisher, by a pump, to a centrifuge, clarifier, and/or a decanter, and the like, which removes any remaining impurities. The puree is then directed to a filler station for canning, bottling, packing, and the like.

As such, the present systems and processes provide for single or multi-format and/or multi-temperature use for processing ingredient into a single or blended puree, including, for example, baby food purees, without the addition of water and minimal heating abuse. See Examples below. The aesthetic and flavor qualities are maintained by separating pulp from waste product prior to any heating and/or cooking steps and therefore the resulting end-product in an acceptable baby food puree/formulation. For fresh ingredients, some of the present embodiments provide for removal of any treatments or contaminants that may be on the external surface of the product prior to being processed.

An acceptable baby-food formulation, moreover, will also have a texture that is satisfactory to the baby. For example, foods that are too dry or gritty are usually unacceptable to infants. In general, acceptable baby-food formulations will be smooth in texture, while, in addition, younger infants typically prefer food that is soft and homogenous. Older infants, however, may prefer a nonhomogenous texture. Because of the variety of such preferences, baby foods are typically produced in different forms, depending on the age of the intended consumer. For example, Beech-Nut Stage 1 products are intended to be consumed by infants from about four months of age. Beech-Nut Stage 2 products, which are strained and will pass through an orifice ranging from about 0.1, 0.2, 0.3 or 0.4 mm or inches to about 0.2, 0.3, 0.4, 0.5, 0.6 or 0.7 mm or inches are intended to be consumed by infants from about six months of age. Infants of about nine months of age and older are the intended consumers of Beech-Nut Stage 3 products, which have chunky components that have been passed through a screen slightly larger that stage 1 and/or 2 products.

The acceptability of the baby-food compositions in the various embodiments of the present invention, includes the organoleptic acceptability, which can be measured, for example by determining the value on a nine-point hedonic scale. A composition is considered, herein, to be organoleptically acceptable if the Appearance/Color, Flavor, and Mouthfeel/Texture of the composition each score at least about five or greater on a nine-point hedonic scale. As such, the organoleptic acceptability in terms of Mouthfeel/Texture can be achieved by processing the baby-food compositions using the methods and systems of the present disclosure, where the puree products score at least five on a nine-point hedonic scale.

An acceptable baby-food formulation is also one suitable for feeding to a baby and included within the meaning of the terms acceptable baby-food formulation is any regulatory agency requirements for foods intended for consumption by infants. For example, lactic acid and malic acid have been reviewed by the Food and Drug Administration and determined not to be generally recognized as safe for use in baby foods for infants in the first year of life. In addition, an acceptable baby-food formulation is one whose overall combination of organoleptic characteristics, e.g., taste, mouthfeel or texture, odor and color or appearance, is sufficiently satisfactory that the infant will consume the formulation and the caregiver will serve the formulation to the infant.

For example, infants are known to display an aversion to bitter tastes at a very early age and to strong flavors such as can be present in some vegetables. See Trahms, Nutrition in Infancy and Childhood, Pipes and Trahms, Eds, Mosby, St. Louis, 1993, pp. 181-194; Kajiura et al., Developmental Psychobiol 25:375-386; Rosenstein et al., Child Develop 59:1555-1568, 1988; Lowenberg, Nutrition in Infancy and Childhood, Pipes and Trahms, Eds, Mosby, St. Louis, 1993, pp. 165-180; Brooks, The Wall St J, Dec. 4, 1996 pp A1, A6; Lawless, J. Am. Diet. Assoc. 85:577-585, 1985; Ashbrook et al., J. Nutrition Ed 17:5, 6, 60 46, 1985; Beal Pediatrics 20:448-456, 1957. Therefore, an acceptable formulation of a baby-food composition can be a formulation that is organoleptically acceptable to an infant. For example, the formulation can be a baby-food composition that does not have a strong bitter taste or a strong flavor such as can be present in some vegetable preparations of the present disclosure, e.g., sweet potato purees.

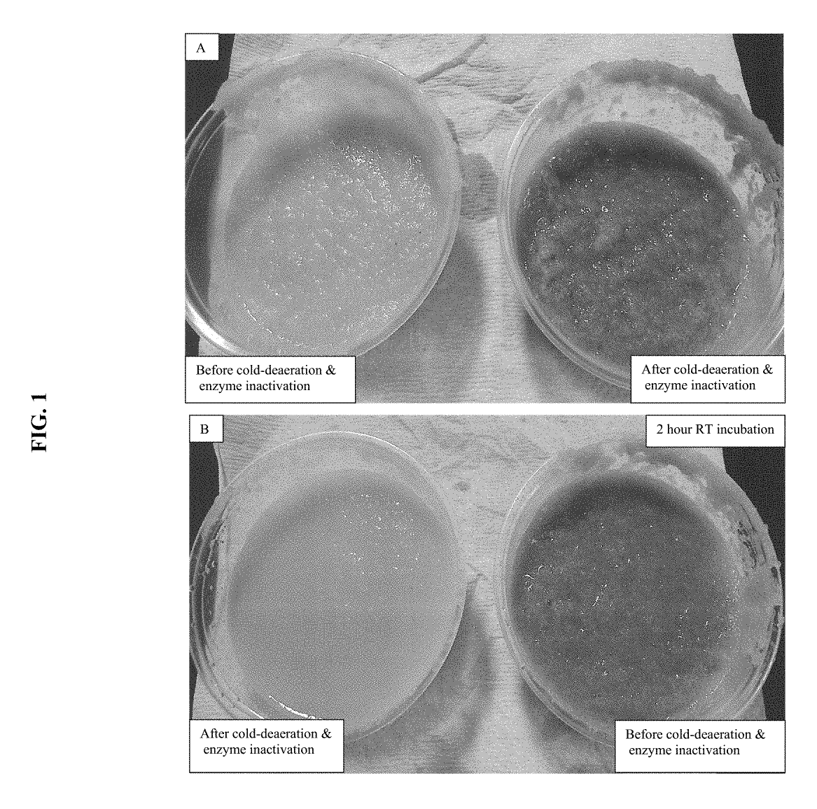

In illustrative embodiments, the desired texture is achieved by using whole food ingredients and mixing such components having the desired texture. Moreover, the color and appearance of the formulation are such that the infant or the adult caregiver will not reject the formulation based on produce expectation. Acceptable colors tend to be light rather than dark, while an acceptable color is achieved by adding and/or mixing the appropriate ration of food components which consequently produce the desired color for an intended puree. The appearance of the formulation should also be smooth and homogenous. See FIG. 1 and Examples for data concerning fruit products.

In illustrative embodiments, some of the fruit and/or vegetable combinations include one or more of the following ingredients, which can be combined depending on any particular receipt formulation, as follows: Sweet Potatoes, Apples, Pears, Black Pepper, Celery Powder, Frozen Squash Puree, IQF Black Beans, IQF Green Peppers, Rolled Oats, IQF Broccoli, IQF Strawberries, Dry Quinoa, Fresh Bartlett Pears, Fresh Butternut Squash, Fresh, Frozen and/or IQF Sweet Potatoes, Cinnamon, Frozen Raspberry Puree, IQF Blueberries, IQF Butternut Squash, IQF Zucchini, Onion Flakes, IQF Black Cherry, Water, IQF Peas, IQF Green Beans, Heavy Cream, Fresh Apple, IQF Carrots, Barley Flakes, Raisin Paste, Lemon Juice Concentrate, Paprika, Frozen Spinach Puree, IQF Aroniaberries, IQF Asparagus, IQF Beets, IQF Blackberries, IQF Cranberries, IQF Kiwis, IQF Oranges, IQF Mandarin Oranges, Chia Seed, IQF Pineapples, IQF Pomegranate Arils, Aseptic Mango Puree SS, Dry Amaranth, Fresh Honey Crisp Apples, Frozen Asparagus Puree, Frozen Avocado Puree, Frozen Banana Puree, and/or Frozen Pumpkin Puree.

FIG. 2 shows an illustrative embodiment of a method for producing a baby food puree in accordance with the present disclosure. In operation 100, drum dumper 110, IQF tote dumper 120, frozen tote dumper 121 and/or fresh infeed ports are employed depending on the starting food ingredients. Turbo chopper 140 is shown in operation 100 with respect to ingredients first directed to IQF crusher/chopper 150 and/or IQF-Frozen Puree crusher/chopper 160. Elevator conveyor 170 is shown in operation 100 with load cells to meter the infeed lines. In operation 100, cold extractor 180 is employed for extraction of the constituent ingredients, while mono-pump 190 directs the extracted ingredients to cold deaerator 200. Surge tank 210 is also provided for operation 100, as necessary. Following either or both of cold deaeration 200 and surge tank option 210, mono-pump 190 shunts the deaerated puree, optionally, to aseptic-frozen puree injectors 220, which then feeds the puree to tri-valve 230 in operation 100. Thereafter, the ingredients of operation 100 proceed to thermal inactivator 240 for enzyme inactivation.

### Processing Methods for Sweet Potatoes and Other Produce

Sweet potatoes (ipomoea batatas) are an important crop in developing countries and worldwide at least because such a crop has wide production geography, adaptability to marginal conditions, short production cycles, high nutritional value and sensory versatility in terms of flesh colors, taste and texture. Depending on the flesh color, sweet potatoes are rich in β-carotene, anthocyanin, total phenolic dietary fiber, ascorbic acid, folic acid and minerals. See, e.g., Woolfe, J. “Sweet potato: an untapped food resource” Cambridge Univ. Press and the International Potato Center (CIP). Cambridge, UK, pp 294-355 (1992). As such, sweet potatoes indeed possess potential for contributing to the human diets, including infants and young children, around the world. Representative sweet potato varieties known in the art include, but are not limited to Allgold, Apache, Beauregard, Brinkley White, Bunch, Carolina Ruby, Centennial, Cherokee, Continental Red, Cordner, Cordner's Red, Covington variety, Dianne, Garnet, Georgia Jet, Hayman, Hernandez, Jewell, Porto Rico and White Delight, etc.

However, recent trends in sweet potato production and consumption do not comport with an increase in the exploitation of this highly nutritious vegetable. In fact, the annual per capita consumption of sweet potatoes has declined in the U.S. over the last few decades. See Angue and Innocence, “Variety evaluation for processing quality acceptability of sweet potato products,” South East Asian program for Potato Research and Development (SAPPRAD) First Year Phase 111. Annual Reports: Sweet Potato; International Potato Center (CIP); Manila, Philippines, Vol. 2, pp. 55-64 (1992). This may be attributable to the inadequacy in sweet potato manufacturing technologies for processed products, and the increased demand of consumers for convenient products.

Nevertheless, there have been several attempts to use sweet potatoes and sweet potato flour in different food products such as butter cookies, pretzels, cakes, hotcake mixes, and instant porridge and as a composite with wheat in the production of noodles and bread. Likewise, research efforts have demonstrated that sweet potatoes can be made into liquid and semi-solid food products such as beverages, soups, baby foods, ice cream, baked products, restructured fries, breakfast cereals, and various snack and dessert items and also composite flour. See Woolfe (1992); See Malomo “Effect of Blanching and Unblanching on Rheological Properties of Sweet-Potato Bread,” SAVAP International; Vol. 4, No. 3, pp. 24-47 (2013).

In previous attempts to produce the characteristic flavor of a baked sweet potato, natural sweet potato enzymes, such as, e.g., one or more amylase enzymes, such as, for example, glucoamylase, have been added to the puree during processing to convert the sweet potato starch into its constituent sugars, such as, e.g., glucose, sucrose, fructose, and maltose, in a process termed dextrinization. See, e.g., U.S. Patent Publication No. 2011/0177199. In this regard, α-amylases, e.g., α-(1,4)-glucan-4-glucanohydrolase, hydrolyze α-(1,4)-linkages to yield a mixture of glucose, maltose, maltotriose and higher sugars. See e.g., U.S. Pat. No. 4,113,509. This enzyme functions, inter alia, as a maltogenic enzyme by acting on starches, glycogen, polysaccharides and oligosaccharides in a random manner such that the reducing groups are liberated in the alpha-configuration, where the term “alpha” relates to the initial anomeric configuration of the free sugar group released and not to the configuration of the linkage hydrolyzed.

Such enzymes described above are activated and inactivated by changes in temperature. As such, producing baby food purees from sweet potatoes may require a heating step in some embodiments, where the puree is heated to about from 100, 115, 130, 140 or 150° F. to about from 120, 130, 140, 150, 160 or 170° F. In illustrative embodiments, the heating is about from 130° F. to about 140° F. to activate the amylase enzymes. Such heating is provided by the inherent thermal pulses of an extractor as described above in some embodiments. The puree is then maintained at the elevated temperature in certain embodiments, for from about 1, 2, 3, 4, 5, 6, 7, 8, 9, 10, 15, or 20 min to from about 2, 3, 4, 5, 10, 15, 20, 30, 40 or 50 min. In suitable embodiments, the time ranges about from 1, 2, 3, 4 or 5 min to from about 7, 8, 9 or 10 min. In illustrative embodiments, the time is about, e.g., 5-10 minutes. Enzyme inactivation, moreover, requires a higher temperature as noted above, e.g., ˜205° F., which accordingly halts the starch-sugar enzymatic catalysis.

Methods described herein entail, in suitable embodiments, the enzymatic catalysis of starch—via native enzymes—which convert the sweet potato starch (a polysaccharide with amylose and amylopectin molecules) into its saccharide components. This process occurs when endogenous sweet potato amylase enzymes, e.g., α-amylase, hydrolyze α-(1,4)-linkages of amylose to yield a mixture of glucose, maltose, fructose, sucrose, maltotriose and higher sugars. See, e.g., U.S. Pat. No. 4,113,509. Amylose may also be hydrolyzed by β-amylase, which cleaves successive maltose units beginning from the non-reducing end to quantitatively yield maltose. The α and β-amylases also hydrolyze amylopectin. This process is maintained throughout the present invention, without the addition of exogenous enzymes, preservatives, water, or anti-oxidants, as follows.

IQF unblanched sweet potatoes, for example, are subjected to cold extraction to produce a puree, which immediately undergoes cold deaeration thereafter. Subsequently, the cold puree is heated via a 5-10 minute heating profile consisting of an initial temperature from 70-80° F. to a final temperature of 205° F. During this temperature transition, the native amylase enzymes are activated, thereby converting the starch to its component sugars, and then denatured as the temperature increased and the puree reached 190° F. and above, which consequently eliminates all enzymatic activity, including the saccharolytic amylase activity.

Other methods entail using IQF frozen sweet potatoes with the natural enzymes rendered inert per the freezing process. Such methods, however, require reconstitution of the inactivated enzymes with commercially available constituents, such as, for example, α-amylase. Glucoamylase, which functions to degrade starch into maltose and glucose, has also been described as noted above, but nevertheless produces a slightly sweeter product than the natural amylase-containing purees. Purees produced in this regard are comparable sweet potato product from a frozen ingredient, but the final product nevertheless contains exogenous recombinant enzymes, and therefore constitutes a product that cannot be classified as “all-natural.” To this end, the U.S. Food and Drug Administration (FDA) has stated that, from a food science perspective, it is difficult to define a food product that is “natural” because the food has probably been processed and is no longer the product of the earth. Nevertheless, the FDA has not developed a definition for use of the term natural or its derivatives. However, the agency has not objected to the use of the term if the food does not contain added color, artificial flavors, or synthetic substances. See FDA guidelines, FDA Transparency and Food Basics (2012).

Furthermore, products made from fresh sweet potatoes that have been peeled, blanched, diced, optically sorted, and individually quick frozen (IQF), have been produced by the present inventors in control experiments. Due to the blanching step, however, the amylase activity that would otherwise be present was limited, which consequently produced a puree that lacked the characteristic sweetness of a sweet potato. As such, in order to produce an acceptable puree from such an IQF raw material, enzyme reconstitution—to convert the starch to sugars, to mimic the enzymatic activity that was lost per the blanching process—was required insofar as a blanching step was previously employed.

Fresh sweet potatoes, moreover, require peeling to maintain the characteristic orange color of the fresh ingredient. Such peeling removes the skin and native surface-tropic enzymes such as polyphenol oxidase, which can discolor a sweet potato puree if not properly inactivated, degraded or removed. This inactivation can be accomplished in several ways, such as, e.g., by heat from a steam peeler, mechanical inactivation, or by employing caustic solutions such as NaOH, i.e., lye peeling, to denature the enzyme.

Cold extraction of fresh sweet potatoes as detailed above, however, is limited to the extent that the macerating and screening to this end typically fail to completely remove, denature or inactivate the polyphenol oxidase. For example, the present inventors employed a screen size ranging from about 0.05 to about 0.035 mm or inches to remove the skin from the sweet potato ingredients, and thereby the undesired surface enzymes, but the resulting puree was nevertheless a darker color than desired. The puree also did not possess the desired flavor, which was likely due to an incomplete and/or insufficient conversion of the native starch to sugars such as, for example, sucrose, fructose, maltose, and glucose.

Freshly harvested sweet potatoes, moreover, are typically cured by exposure to temperatures of about 85° F. and high relative humidity for about four to seven days to allow the tuber to heal any injuries received during harvesting and handling. See U.S. Pat. No. 5,837,309. During the home baking of sweet potatoes, the gradual rise in the internal temperature of the sweet potato acts first to activate amylolytic (amylose starch hydrolyzing) enzymes naturally present in the sweet potato and later to inactivate these enzymes as the tuber becomes fully cooked. The amylolytic enzymes convert the amylose type of starch into simpler carbohydrate molecules, particularly maltose, which gives the characteristic sweet mellow flavor of baked sweet potatoes. See U.S. Pat. No. 5,837,309.

It is known to those skilled in the art that commercial processing of sweet potatoes into a puree suitable for baby food requires a similar time course of temperature exposure to effect this activation and subsequent inactivation of the amylolytic enzymes present in sweet potatoes, in order to achieve the natural sweet mellow flavor of sweet potatoes and also to reduce the amount of the amylose type of starch, which is known to be more likely to separate from the sterilized sweet potato puree, causing the phenomenon known as “starch separation.” See U.S. Pat. No. 5,837,309.

Previously, commercial processing of sweet potatoes involved comminuting peeled sweet potatoes, heating the comminuted sweet potatoes to a temperature of no less than about 140° F. and no more than about 180° F., holding the comminuted sweet potatoes at this temperature for a period of time until the desired degree of conversion of amylose starch to simpler carbohydrate has been achieved, and then increasing the temperature of the comminuted sweet potatoes to a temperature equal to or greater than 190° F. to inactivate the amylolytic enzymes. See U.S. Pat. No. 5,837,309. Failure to effect this enzymatic conversion of the amylose starch of sweet potatoes is known to cause “starch separation” in the finished baby food. See U.S. Pat. No. 5,837,309.

The use of an aseptic process for making a sweet potato puree also has its difficulties. One reason for such difficulty is that the sweet potato product must be processed to commercial sterility, which will then have to be repeated per manufacturer repackaging. This second processing, which is typically performed at 250° F., causes discoloration of the final puree product and may degrade flavor profiles. The color can be protected by adding ascorbic acid and/or citric acid, which respectively function as anti-oxidants and preserving agents, but the addition of such exogenous ingredients precludes the production of a final puree that is all-natural. Indeed, the “Complete Guide to Home Canning,” Agriculture Information Bulletin No. 539, USDA (Revised 2009) provides guidelines for ensuring high-quality canned foods to maintain color and flavor, as follows.

To maintain good natural color and flavor in stored canned foods, such as, for example, sweet potatoes, only high-quality foods, which are at the proper maturity and are free of diseases and bruises should be used, while hot-packing methods (processing foods in boiling water) should be employed for acidic foods. It is also recommended that prepared foods should be unnecessarily exposed to air, and they should be canned as soon as possible. Id. To this end, while preparing a canner load of jars, it is recommended to keep peeled, halved, quartered, sliced, or diced apples, apricots, nectarines, peaches, and pears in a solution of 3 grams (3,000 milligrams) ascorbic acid to 1 gallon of cold water. This procedure is also useful in maintaining the natural color of mushrooms and potatoes, and for preventing stem-end discoloration in cherries and grapes.

Ascorbic acid can be obtained in several forms, according to the guidelines, such as, for example, pure powdered form, i.e., seasonally available among canners' supplies in supermarkets. The use of 1 teaspoon per gallon of water as a treatment solution is also recommended. Likewise, vitamin C tablets can be employed insofar as they are economical and available year-round in many stores, where it is suggested that 500 mg tablets should be crushed and dissolved at 3 g per gallon of water as a treatment solution. Id. Commercially prepared mixes of ascorbic and citric acid are also seasonally available among canners' supplies in supermarkets. See id. Sometimes citric acid powder is sold in supermarkets, but it is less effective in controlling discoloration according to the guidelines above. When using such products, it is recommended to follow the manufacturer's directions. The guidelines further suggest that jars should be stored in a relatively cool, dark place, preferably between 50° F. and 70° F. Id.

In accord, U.S. Pat. No. 6,368,654 teaches the addition of ascorbic acid to protect a puree from the enzymatic browning that occurs when fruits are cut. Utilizing a cold deaeration step directly after the extraction step, however, as in the presently claimed invention, eliminates the need for the addition of ascorbic acid due to the reduction of and removal of oxygen, which the enzymes require to function, as further detailed below. Furthermore, U.S. Pat. No. 8,247,017 describes a process for making frozen potatoes, which includes the steps of slicing and then applying citric acid juice, preferably, lemon juice, to the slices. A coating then is applied to the slices, which includes a mixture of corn syrup, honey, brown sugar, lemon flavor and vanilla flavor. Again, as detailed above, such processes impart added ingredients proscribed from an all-natural label.

As with many fruit and/or vegetable processing methods, sweet potato processing begins with fresh and/or frozen produce, or the use of aseptic puree ingredients. However, the present inventors discovered that IQF from fresh sweet potatoes, which were diced, unblanched and optically sorted, prior to freezing, produced a sweet potato puree that possessed excellent flavor, taste, color, and sugar profile. See Examples below. This product also possessed amylase enzymatic profiles similar to profiles of fresh sweet potatoes. Id.

The discovery that blanching was deleterious to the production of an acceptable baby food puree was surprising at least to the extent that blanching has been asserted as a necessary step in vegetable and sweet potato processing with respect to enzyme inactivation, i.e., for inhibiting subsequent discoloration. See U.S. Pat. No. 8,247,017 citing U.S. Pat. No. 3,644,129. The blanching process involves a special heat treatment to inactivate enzymes, which is also a unit operation prior to freezing, canning, or drying in which they are heated for the purpose of inactivating enzymes, modifying texture, preserving color, flavor, and nutritional value. See Malomo “Effect of Blanching and Unblanching on Rheological Properties of Sweet-Potato Bread,” SAVAP International; Vol. 4, No. 3, pp. 24-47 (2013).

The blanching process also involves an unsteady heat transfer treatment (conduction and convection) either by steam or hot/boiling water. Time and temperature regime of blanching depends on the nature and the source of the material and the final processing to be employed. According to Malomo (2013), blanching is not indiscriminate heating fresh cut potato turn brown when iron-containing chemicals in the potato react with oxygen in the air in a chemical reaction term oxidation. Id. Furthermore, blanching inhibits enzymes that degrade provitamin A such as lipoxygenases and peroxidases. The effect of blanching on vegetables entails the inhibition of enzymes such asperoxidases, lipoxygenases and chloropyllases and protases, all of which are responsible for stabilizing the nutritional values of the product. Blanching additionally facilitates peeling and dicing, and is also accompanied by microbial load reduction. Id.

Hot water and steam are the most commonly used heating media for blanching in industry, but microwave and hot gas blanching have also been studied. Id. Different hot water and steam blanchers have been designed to improve product quality, increase yield, and facilitate processing of products with different thermal properties and geometries. See Malomo (2013). As further discussed in Malomo (2013), there are nevertheless several ways to inhibit oxidation, e.g., anti-oxidants such as ascorbic acid can be added to food, while lemon juice, for example, will inhibit potatoes the browning of a freshly cut potatoes because lemons are high in citric acid, an anti-oxidant. Id. Sulphur dioxide, moreover, used in the commercial processing of many foods, does the same thing. Id.

Likewise, U.S. Pat. No. 8,247,017 notes that apart from the use of blanching as a flavor and color preservative technique, there is a shortage of methods for producing frozen potatoes having flavorful coatings, yet the use of a flavorful coating for sweet potatoes is highly desirable according to the foregoing document. To this end, this reference employed citric acid to account for the absence of a blanching step, where the potatoes are sprayed with lemon juice to maintain their color and natural sweetness, while further applying a coating solution that included corn syrup, honey, brown sugar, lemon flavor, and vanilla flavor. To the same end, U.S. Pat. No. 6,368,654 teaches that ascorbic acid is preferably added to a cold break either during or immediately after a cold extraction step, where the ascorbic acid assists in alleviating discoloration of the broken raw produce.

Furthermore, as discussed in U.S. Pat. No. 4,632,834, blanched sweet potatoes should be coated with orange juice and then frozen. Likewise, as detailed in “Preserve it right-Freezing fruits and vegetables,” Iowa State University, Univ. Extension, September 2001, enzymes in foods cause changes in flavor, color, texture and nutritive value. Freezing slows this activity but does not stop it, where if preventing further enzyme activity is desired, vegetables need to be blanched in boiling water or steamed before freezing. See id at col. 1. Enzymatic browning in light colored foods, however, can be prevented by using ascorbic acid mixtures or other substances, according to the foregoing reference. The publication “Freezing Yams or Sweet Potatoes,” LSU Agricultural Center Research & Extension (1964), moreover, states that boiled potatoes are best cooked and then dipped in ascorbic acid dissolved in a little water or in lemon or orange juice to preserve the natural characteristics of the food.

Accordingly, the present scientific literature and methods for producing a vegetable puree require a blanching step for maintaining the color and flavor of a food product and/or the addition of an anti-oxidant or preservative, such as ascorbic acid or citric acid, to account for the absence of a blanching step. Nevertheless, the present invention entails the production of a puree in the absence of either such manipulation, where unblanched, frozen, diced, sweet potatoes are used, which allows the natural amylase enzymes to convert the starches to sugars such as maltose and glucose, to give the puree the typical baked sweet potato flavor, where the resulting—all-natural—sweet potato product possesses excellent flavor, taste and sugar profile, and has amylase enzymatic profiles similar to profiles of fresh sweet potatoes. Likewise, the use of cold deaeration eliminates the air so that the puree does not get discolored by the natural polyphenol oxidase enzyme. See Examples below.

Briefly, the present systems and processes include, but are not limited to, providing unblanched IQF sweet potato dices on an inspection table for visual sorting to ensure foodstuff quality. The dices are then introduced to a VFX Bertocchi cold extractor at about 25-40° F. with the thermal pulse on. The puree is subsequently and immediately directed to the cold deaerator where the air is removed. After increasing the temperature to activate endogenous enzymes, e.g., amylase enzymes, as described herein, residual enzymatic oxidation is then curtailed when the puree is subjected to a temperature of about 205° F. to inactivate enzymatic processes of the native oxidative enzymes. After enzyme inactivation, the puree is directed to a holding tank, pumped through a set of in-line strainers and magnets, and then to a filler station, where the final product is filled in glass jars and capped in some embodiments. Subsequently, filled and capped jars proceed to, e.g., a retort department, where low acid sweet potato products are processed to commercial sterility, labeled and then cased in illustrative embodiments.

In some embodiments, the processed fruit and/or vegetable products are vacuum packed in a container, while in other embodiments, the processed fruit or vegetable products are sealed in cans, jars or plastic cups. The processed fruit or vegetable products are packaged in a modified or controlled atmosphere container in illustrative embodiments. Such modified or controlled atmosphere may comprise elevated carbon dioxide levels, elevated nitrogen levels, reduced oxygen levels, reduced ethylene levels, or any combination thereof.

The present invention also relates to storing the processed fruit or vegetables prior to or subsequent to packaging. In illustrative embodiments, the processed fruit or vegetables are stored prior to packaging, while they can also be stored subsequent to packaging. In some embodiments, the fruit or vegetables are stored and/or packaged prior to processing. In this regard, uncut fruit or vegetables are stored in an environment with a temperature range from about 30-80° F. prior to extracting, cutting, comminuting, etc. In illustrative embodiments, uncut fruit or vegetables are stored in an environment with a relative humidity range of 85-95%. The processed fruits and/or vegetable products of the present invention possess a shelf-life from about 5, 10, 15, 20, 30, 40, 50 or 60 days, weeks or months to about from 15, 20, 30, 40, 50, 60, 70, 80, 90, 100 or 120 days, weeks or months. In illustrative embodiments, the shelf-life of the product of the present invention is about 18 months. Some embodiments of the presently claimed invention include harvesting, processing and packaging the fruit and/or vegetables all within 1 to 7 days.

The present system further entails achieving a puree with increased viscosity due to eliminating the activity of the naturally occurring enzymes in some embodiments. Likewise, by eliminating the requirement of adding ascorbic acid, citric acid and/or any other preservatives or enhancer treatments for preservation of color, the present systems allows for the production of an all-natural product with minimal manipulation, while also maintaining the natural constituents, flavors and vapors by the elimination of excessive cooking steps.

FIG. 2 shows an illustrative embodiment of a method for producing a sweet potato baby food puree in accordance with the foregoing description. In operation 100, IQF tote dumper 120 and/or frozen tote dumper 121 infeed ports are employed with respect to the respective sweet potato ingredients. Turbo chopper 140 is shown in operation 100 with the sweet potato ingredients first directed to IQF crusher/chopper 150 and the IQF-Frozen Puree crusher/chopper 160. Elevator conveyor 170 is shown in operation 100 with load cells to meter the infeed lines. In operation 100, cold extractor 180 is employed with respect to the sweet potato ingredients, while mono-pump 190 directs the extracted sweet potatoes to cold deaerator 200. Surge tank 210 is also provided for operation 100, should it be required. Following either or both of cold deaeration 200 and surge tank option 210, mono-pump 190 shunts the deaerated sweet potato puree to tri-valve 230 in operation 100. Thereafter, the sweet potato ingredients in operation 100 proceed to thermal processor 240 for activating and subsequent enzyme inactivation of the sweet potato puree.

In illustrative embodiments, a fruit puree product—containing no additives—is also provided. In the production of fruit purees, once a fruit is cut, enzymatic browning reactions immediately ensue, where the enzymes require the presence of oxygen to function. With respect to the cold extraction process to this end, after the fresh fruit is macerated and strained, it is pumped through a cold deaeration tank where the entrapped air is removed by vacuum, as described herein. This accordingly imparts a stable puree, with limited or no oxygen present, thus slowing down the browning reaction. The next step, in this regard, is to pump the deaerated puree through the enzymatic inactivator where the puree is heated to approximately 205° F. The resultant puree is stable even when exposed to air. The foregoing steps eliminate the need for adding ascorbic acid and/or citric acid as anti-oxidants to the fruit purees to keep them from turning brown. See FIG. 1 and Examples below.

Apples varieties within the scope of the present invention include, but are not limited to: Red Delicious, Golden Delicious, Gala, Fuji, Rome, Ginger Gold, Granny Smith, Braebum, Cameo, Pink Lady, Jonagold, Rome Beauty, Wealthy, Stayman, Jonathan, Mcintosh, Cortland, Akane, Jonamac, Nittany, Vista Bella, Elstar, Royal Gala, Winter Banana, or any combination of these or any other varieties. Particular varieties of pears that may be used in certain embodiments include, but are not limited to: European or Asian pears, Bartlett, Red Bartlett, Taylor's Gold, Concorde, Seckel, Red Anjou, Green Anjou, Bose, Comice, Forelle, D'Anjou, Clairgeau, Easter Beurre, Flemish Beauty, Kieffer, Pound, Sheldon, Winter Nelis, P. Barry, or any combination of these or any other varieties.

### EXAMPLES

The present systems and processes are understood more readily by reference to the following examples, which are provided by way of illustration and are not intended to be limiting.

### Process Methods

One of the underlying components of the processes described herein concerns the enzymatic catalysis of starch—via native enzymes—which convert the sweet potato starch (a polysaccharide with amylose and amylopectin molecules) into its saccharide components. This process occurs when endogenous sweet potato amylase enzymes, e.g., α-amylase, hydrolyze α-(1,4)-linkages of amylose to yield a mixture of glucose, maltose, fructose, sucrose, maltotriose and higher sugars. Amylose may also be hydrolyzed by β-amylase, which cleaves successive maltose units beginning from the non-reducing end to quantitatively yield maltose. The α and β-amylases also hydrolyze amylopectin. This process is maintained throughout the present invention, without the addition of exogenous enzymes, preservatives, water, or anti-oxidants, as follows.

IQF unblanched sweet potatoes were subjected to cold extraction to produce a puree, which immediately underwent cold deaeration. Subsequently, the cold puree was heated via a 7 minute heating profile consisting of an initial temperature from 70-80° F. to a final temperature of 205° F. During this temperature transition, the native amylase enzymes were activated, thereby converting the starch to its component sugars, and then denatured as the temperature increased and the puree reached 190° F. and above, which consequently eliminated all enzymatic activity, including the saccharolytic amylase activity.

### Enzyme Activity

Fresh sweet potatoes possess a high concentration of polyphenol oxidase, which ascribes a dark brown color for purees made from fresh, unpeeled sweet potatoes. As such, the sweet potatoes were peeled to eliminate any detectable polyphenol oxidase activity. Such peeling is sufficient in this respect at least because the polyphenol oxidase enzyme resides near the surface of the sweet potato, i.e., at the skin. Accordingly, it was determined that the level of amylase activity in the fresh sweet potatoes is twice that of the IQF blanched sweet potatoes, while the level of amylase activity inherent to unblanched IQF sweet potatoes is much closer to the fresh than the IQF blanched sweet potatoes, which consequently imparts the reduced amylase activity with respect to blanched sweet potatoes.

This is congruent with the intention of the blanching operation, which is designed to eliminate all enzyme activity by the use of hot water and/or steam for an extended period of time. Consequently, because the unblanched sweet potatoes used pursuant to the present invention are peeled, but not subjected to blanching or heating, the native amylase enzymes are active under the proper conditions, which is not reduced by the freezing process. See Table 1. In short, enzyme and nutritional analyses were assessed for fresh cured sweet potatoes, IQF unblanched sweet potatoes, and IQF blanched sweet potatoes, where blanching was performed for 30 seconds at 200° F. See below and Table 1A.

DATA CHART 1

| | Polyphenol oxidase | α-amylase |
|---|---|---|
| | activity (units/ml) | activity (CU/g) |
| Fresh | 1824 | 0.13 |
| Blanched IQF | 0 | 0.06 |
| Unblanched IQF | 0 | 0.1 |

### Sugar Data

The majority of the starch conversion that occurs pursuant to the native amylase enzymes precipitates an increase in maltose formation. This is shown by comparison of the fresh unprocessed and fresh processed sweet potatoes in concert with the IQF unblanched unprocessed and processed produce. See Data Chart 2 below. To this end, the data from the IQF blanched sweet potatoes possess the same level of maltose in the unprocessed sample as well as the processed samples. In short, because the blanching process denatures the native amylase enzymes of the diced sweet potatoes, i.e., after the dices are subjected to a temperature gradient allowing for enzymatic catalysis of starch to sugar, no further conversion of starch to sugar can occur during the puree production process.

Data from the unblanched IQF sweet potato samples show that they behave much like the fresh sweet potatoes, where the maltose levels from the unprocessed ingredients is very low compared to the processed ingredients. Furthermore, the temperature profile necessary for enzymatic catalysis of the native starches, via amylase activity, is incorporated into the cold extraction processing parameters. See Data Chart 2 and Tables B-H. Briefly, FIG. 4 shows charts providing data from analyses of various types of vegetable preparations, including the foregoing preparations. As such, in addition to the enzymatic activity profiles of fresh, blanched IQF and unblanched IQF sweet potato preparations noted above, Tables B-H respectively provides nutrient profiles for fresh processed, IQF blanched (135-150° F.), IQF blanched (150-165° F.) processed, fresh unprocessed, frozen blanched unprocessed, IQF unblanched unprocessed and IQF unblanched processed sweet potato preparations.

DATA CHART 2

| | | Fruc- | Glu- | Su- | Malt- | |
|---|---|---|---|---|---|---|
| | Solids | tose | cose | crose | ose | Total |
| Fresh processed | 17.86 | 0.483 | 0.897 | 4.2 | 3.99 | 9.57 |
| Fresh unprocessed | 20.079 | 0.334 | 0.636 | 4.71 | 0 | 5.68 |
| IQF blanched 135-150° F. | 16.076 | 0.593 | 0.933 | 2.85 | 2.35 | 6.726 |
| processed | | | | | | |
| IQF blanched 150-165° F. | 15.589 | 0.598 | 0.71 | 2.71 | 2.68 | 6.698 |
| processed | | | | | | |
| Frozen blanched | 15.733 | 0.441 | 0.593 | 3.01 | 2.86 | 6.904 |
| unprocessed | | | | | | |
| IQF unblanched processed | 21.0336 | 0.696 | 0.894 | 2.68 | 4.45 | 8.72 |
| IQF unblanched | 22.426 | 0.75 | 0.934 | 3.05 | 0.895 | 5.629 |
| unprocessed | | | | | | |

The nutrient profiles consisted of measurements with respect to moisture content, fructose, glucose, sucrose, maltose, lactose, total sugars, alpha carotene, trans beta carotene, cis beta carotene, total beta carotene, total carotene, potassium, magnesium, vitamin B1 (thiamine-HCl; US), vitamin B1 (thiamine; EU), vitamin B2 (riboflavin) and vitamin B6. See Tables B-H below.

### Solids Data

The solids data show that the use of IQF raw materials into the cold extraction system does not change the measured level of solids, which therefore indicates that no additional water is added pursuant to the present process. This is because the sweet potato skin contains less water than the flesh, where the majority of the skin is removed per the peeling and cold extraction steps. See Tables B-H below.

As such, use of unblanched frozen sweet potato dices and/or chunks delivered the same finished product as compared to the use of fresh sweet potatoes. This is at least because the amylase enzyme activity, being roughly the same, converted the starch to sugars, i.e., primarily maltose as noted above in Data Chart 2. By contrast, when using IQF blanched sweet potatoes, starch conversion is exhausted without the addition of exogenous amylase enzymes. The present inventors found that, in this regard, this product is thicker than what is acceptable. See Tables B-H below.

Likewise, using fresh ingredients imparts an unacceptable aftertaste, which is likely due to residual sweet potato skin that has not been removed. The puree also is darker than normal due to the presence of the polyphenol oxidase enzyme that turns the product dark upon exposure to oxygen in this respect. The unblanched product, as noted above will not have this problem as it has had the polyphenol oxidase activity eliminated by the peeling of the sweet potatoes. As shown in the Tables above, the data indicate that the cold extraction system does not add water to the purees. See Tables B-H below.

In short, Tables A-G below provide data from analyses of various types of vegetable preparations. Table A provides enzymatic activity profiles of fresh, blanched IQF and unblanched IQF sweet potato preparations Table B provides nutrient profiles for fresh processed sweet potato preparations. Table C provides nutrient profiles for IQF blanched (135-150° F.) processed sweet potato preparations. Table D provides nutrient profiles for IQF blanched (150-165° F.) processed sweet potato preparations. Table E provides nutrient profiles for fresh unprocessed sweet potato preparations. Table F provides nutrient profiles for Frozen blanched unprocessed sweet potato preparations. Table G provides nutrient profiles for IQF unblanched unprocessed sweet potato preparations. Table H provides nutrient profiles for IQF unblanched processed sweet potato preparations. Tables B-H below.

TABLE A

| | | |
|---|---|---|
| Assay Group | Test | Results |

Fresh Sweet Potatoes

| Sample Handling | Sample Process Fee | Sample Processed | |
|---|---|---|---|
| Processing Level 1 | | | |
| ²Polyphenoloxidase | Polyphenoloxidase | 1824 | Units/mL |
| ²Alpha Amylase | alpha Amylase Activity | 0.13 | CU/g |

IQF Frozen Blanched Sweet Potatoes

| Sample Handling | Sample Process Fee | Sample Processed | |
|---|---|---|---|
| Processing Level 1 | | | |
| ²Polyphenoloxidase | Polyphenoloxidase | <LOQ | Units/mL |
| ²Alpha Amylase | alpha Amylase Activity | 0.06 | CU/g |

Frozen Unblanched Sweet Potatoes

| Sample Handling | Sample Process Fee | Sample Processed | |
|---|---|---|---|
| Processing Level 1 | | | |
| ²Polyphenoloxidase | Polyphenoloxidase | <LOQ | Units/mL |
| ²Alpha Amylase | alpha Amylase Activity | 0.10 | CU/g |

TABLE B
Processed Fresh Sweet Potatoes

| Assay Group | Test | Results | |
|---|---|---|---|
| Sample Handling | Sample Process Fee | Sample Processed | |
| Processing Level 1 | | | |
| Moisture | Moisture | 82.143% | |
| Sugars | Fructose | 0.483% | |
| | Glucose | 0.897% | |
| | Sucrose | 4.20% | |
| | Maltose | 3.99% | |
| | Lactose | Less than 0.1% | |
| | Total Sugars | 9.57% | |
| ²Carotenoids | alpha carotene | Less than 0.5 | IU/100 g |
| | trans beta carotene | 7750 | IU/100 g |
| | cis beta carotene | 980 | IU/100 g |
| | Total beta Carotene | 8730 | IU/100 g |
| | Total Carotene | 8730 | IU/100 g |
| Potassium | Potassium | 445 | mg/100 g |
| Magnesium | Magnesium | 22.2 | mg/100 g |
| Vitamin B1 | Vitamin B1 | 0.0400 | mg/100 g |
| (Thiamine) | (Thiamine-HCI (US)) | | |
| | Vitamin B1 | 0.0315 | mg/100 g |
| | (Thiamine (EU)) | | |
| Vitamin B2 | Vitamin B2 | 0.0500 | mg/100 g |
| (Riboflavin) | (Riboflavin) | | |
| Vitamin B6 | Vitamin B6 | 0.283 | mg/100 g |

TABLE C
Processed Frozen Sweet Potatoes, 135-150

| Assay Group | Test | Results | |
|---|---|---|---|
| Sample Handling | Sample Process Fee | Sample Processed | |
| Processing Level 1 | | | |
| Moisture | Moisture | 83.924% | |
| Sugars | Fructose | 0.593% | |
| | Glucose | 0.933% | |
| | Sucrose | 2.85% | |
| | Maltose | 2.35% | |
| | Lactose | Less than 0.1% | |
| | Total Sugars | 6.73% | |
| ²Carotenoids | alpha carotene | Less than 0.5 | IU/1 00 g |
| | trans beta carotene | 7170 | IU/100 g |
| | cis beta carotene | 609 | IU/100 g |
| | Total beta Carotene | 7780 | IU/100 g |
| | Total Carotene | 7780 | IU/100 g |
| Potassium | Potassium | 249 | mg/100 g |
| Magnesium | Magnesium | 18.1 | mg/100 g |
| Vitamin B1 | Vitamin B1 | <0.03 | mg/100 g |
| (Thiamine) | (Thiamine-HCI (US)) | | |
| | Vitamin B1 | <0.02 | mg/100 g |
| | (Thiamine (EU)) | | |
| Vitamin B2 | Vitamin B2 | <0.03 | mg/100 g |
| (Riboflavin) | (Riboflavin) | | |
| Vitamin B6 | Vitamin B6 | 0.086 | mg/100 g |

TABLE D
Processed Frozen Sweet Potatoes, 150-165

| Assay Group | Test | Results | |
|---|---|---|---|
| Sample Handling | Sample Process Fee | Sample Processed | |
| Processing Level 1 | | | |
| Moisture | Moisture | 84.411% | |
| Sugars | Fructose | 0.598% | |
| | Glucose | 0.710% | |
| | Sucrose | 2.71% | |
| | Maltose | 2.68% | |
| | Lactose | Less than 0.1% | |
| | Total Sugars | 6.70% | |
| ²Carotenoids | alpha carotene | Less than 0.5 | IU/100 g |
| | trans beta carotene | 7130 | IU/100 g |
| | cis beta carotene | 657 | IU/100 g |
| | Total beta Carotene | 7790 | IU/100 g |
| | Total Carotene | 7790 | IU/100 g |
| Potassium | Potassium | 243 | mg/100 g |
| Magnesium | Magnesium | 16.9 | mg/100 g |
| Vitamin B1 | Vitamin B1 | <0.03 | mg/100 g |
| (Thiamine) | (Thiamine-HCI (US)) | | |
| | Vitamin B1 | <0.02 | mg/100 g |
| | (Thiamine (EU)) | | |
| Vitamin B2 | Vitamin B2 | 0.0500 | mg/100 g |
| (Riboflavin) | (Riboflavin) | | |
| Vitamin B6 | Vitamin B6 | 0.078 | mg/100 g |

TABLE E
Fresh Sweet Potatoes

| Assay Group | Test | Results | |
|---|---|---|---|
| Sample Handling | Sample Process Fee | Sample Processed | |
| Processing Level 1 | | | |
| Moisture | Moisture | 79.921% | |
| Sugars | Fructose | 0.334% | |
| | Glucose | 0.636% | |
| | Sucrose | 4.71% | |
| | Maltose | Less than 0.1% | |
| | Lactose | Less than 0.1% | |
| | Total Sugars | 5.68% | |
| ²Carotenoids | alpha carotene | Less than 0.5 | IU/100 g |
| | trans beta carotene | 9120 | IU/100 g |
| | cis beta carotene | 146 | IU/100 g |
| | Total beta Carotene | 9270 | IU/100 g |
| | Total Carotene | 9270 | IU/100 g |
| Potassium | Potassium | 603 | mg/100 g |
| Magnesium | Magnesium | 26.0 | mg/100 g |
| Vitamin B1 | Vitamin B1 | <0.03 | mg/100 g |
| (Thiamine) | (Thiamine-HCI (US)) | | |
| | Vitamin B1 | <0.02 | mg/100 g |
| | (Thiamine (EU)) | | |
| Vitamin B2 | Vitamin B2 | 0.0400 | mg/100 g |
| (Riboflavin) | (Riboflavin) | | |
| Vitamin B6 | Vitamin B6 | 0.366 | mg/100 g |

TABLE F
Frozen Sweet Potatoes - Blanched

| Assay Group | Test | Results | |
|---|---|---|---|
| Sample Handling | Sample Process Fee | Sample Processed | |
| Processing Level 1 | | | |
| Moisture | Moisture | 84.267% | |
| Sugars | Fructose | 0.441% | |
| | Glucose | 0.593% | |
| | Sucrose | 3.01% | |
| | Maltose | 2.86% | |
| | Lactose | Less than 0.1% | |
| | Total Sugars | 6.90% | |
| ²Carotenoids | alpha carotene | Less than 0.5 | IU/100 g |
| | trans beta carotene | 8050 | IU/100 g |
| | cis beta carotene | 159 | IU/100 g |
| | Total beta Carotene | 8210 | IU/100 g |
| | Total Carotene | 8210 | IU/100 g |
| Potassium | Potassium | 255 | mg/100 g |
| Magnesium | Magnesium | 17.7 | mg/100 g |
| Vitamin B1 | Vitamin B1 | 0.0700 | mg/100 g |
| (Thiamine) | (Thiamine-HCI (US)) | | |
| | Vitamin B1 | 0.0551 | mg/100 g |
| | (Thiamine (EU)) | | |
| Vitamin B2 | Vitamin B2 | 0.0900 | mg/100 g |
| (Riboflavin) | (Riboflavin) | | |
| Vitamin B6 | Vitamin B6 | 0.097 | mg/100 g |

TABLE G
Frozen Sweet Potatoes - Unblanched

| Assay Group | Test | Results | |
|---|---|---|---|
| Sample Handling | Sample Process Fee | Sample Processed | |
| Processing Level 1 | | | |
| Moisture | Moisture | 77.574% | |
| Sugars | Fructose | 0.750% | |
| | Glucose | 0.934% | |
| | Sucrose | 3.05% | |
| | Maltose | 0.895% | |
| | Lactose | Less than 0.1% | |
| | Total Sugars | 5.63% | |
| ²Carotenoids | alpha carotene | Less than 0.5 | IU/100 g |
| | trans beta carotene | 9430 | IU/100 g |
| | cis beta carotene | 117 | IU/100 g |
| | Total beta Carotene | 9550 | IU/100 g |
| | Total Carotene | 9550 | IU/100 g |
| Potassium | Potassium | 391 | mg/100 g |
| Magnesium | Magnesium | 11.7 | mg/100 g |
| Vitamin B1 | Vitamin B1 | 0.0300 | mg/100 g |
| (Thiamine) | (Thiamine-HCI (US)) | | |
| | Vitamin B1 | 0.0236 | mg/100 g |
| | (Thiamine (EU)) | | |
| Vitamin B2 | Vitamin B2 | <0.03 | mg/100 g |
| (Riboflavin) | (Riboflavin) | | |
| Vitamin B6 | Vitamin B6 | 0.575 | mg/100 g |

TABLE H
Processed Frozen Sweet Potatoes - Unblanched

| Assay Group | Test | Results | |
|---|---|---|---|
| Sample Handling | Sample Process Fee | Sample Processed | |
| Processing Level 1 | | | |
| Moisture | Moisture | 78.964% | |
| Sugars | Fructose | 0.696% | |
| | Glucose | 0.894% | |
| | Sucrose | 2.68% | |
| | Maltose | 4.45% | |
| | Lactose | Less than 0.1% | |
| | Total Sugars | 8.72% | |
| Vitamin A | Vitamin A | Less than 50 | IU/100 g |
| Magnesium | Magnesium | 16.0 | mg/100 g |
| Potassium | Potassium | 333 | mg/100 g |
| Vitamin B1 | Vitamin B1 | <0.03 | mg/100 g |
| (Thiamine) | (Thiamine-HCI (US)) | | |
| | Vitamin B1 | <0.02 | mg/100 g |
| | (Thiamine (EU)) | | |
| Vitamin B2 | Vitamin B2 | 0.0400 | mg/100 g |
| (Riboflavin) | | | |
| Vitamin B6 | Vitamin B6 | 0.100 | mg/100 g |

### Fruits/Pears

When processing fruit purees, such as apples and pears, the present example provides products, which contain no additives. In the production of fruit purees, once a fruit is cut, enzymatic browning reactions immediately ensue, where the enzymes require the presence of oxygen to function. With respect to the cold extraction process to this end, after the fresh fruit is macerated and strained, it is pumped through a cold deaeration tank where the entrapped air is removed by vacuum, as described herein. This accordingly imparts a stable puree, with limited or no oxygen present, thus slowing down the browning reaction. The next step, in this regard, is to pump the deaerated puree through the enzymatic inactivator where the puree is heated to approximately 205° F. And, the resultant puree is stable even when exposed to air.

In brief, fresh pears were directly introduced into the cold extraction unit, and, subsequent to extraction, a sample was obtained and set at room temperature. See FIG. 1A (right side panel). As shown in FIG. 1A (right side panel), this sample showed browning almost immediately. Cold deaeration was then performed and a sample of the same pear puree was obtained after the deaeration step and set at room temperature. See FIG. 1A (left side panel). This sample maintained a natural pear color and did not change color or undergo any browning even after a two hour room temperature (RT) incubation. See FIG. 1B (left side panel); the right side panel of FIG. 1B is the identical sample as from FIG. 1A (right side panel) that was also incubated at RT for two hours.

The foregoing steps eliminate the need for adding ascorbic acid and/or citric acid as anti-oxidants to the fruit purees to keep them from turning brown. As noted above, the two pictures shown in FIG. 1 represent a pear puree prior to (left) and after (right) the cold deaeration step. Prior to deaeration, the puree is brown, while thereafter the puree is an acceptable color. FIG. 1B shows the same pear puree after a 2-hour room temperature incubation, where the puree that has been processed pursuant to the present invention remains an acceptable color and texture. See FIG. 1. Compared to the samples that were not deaerated, the extracted and deaerated pear puree possessed a significantly more natural pear color and texture, which was stable for at least 2 hours at RT. Apple data is not shown, but inasmuch as pears are more susceptible to browning than apples, the foregoing data is congruent with apple purees, among other fruits described herein.

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting. In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

While various aspects and illustrative embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

All references cited herein are incorporated by reference herein in their entireties and for all purposes to the same extent as if each individual publication, patent, or patent application was specifically and individually incorporated by reference in its entirety for all purposes.

What is claimed is:

1. A recipe management process for making a puree, comprising:
(a) providing one or more fruit and/or vegetable ingredients selected from the group consisting of fresh, aseptic, individually quick frozen (IQF) drums and IQF totes, or any combination thereof;
(b) subjecting the one or more ingredients to cold extraction;
(c) subjecting the one or more ingredients to cold deaeration immediately after the cold extraction;
(d) heating the ingredients; and
(e) refining and/or finishing the ingredients to produce a the puree.

2. The process of claim 1, wherein the one or more fruit and/or vegetable ingredients are selected from the group consisting of peaches, pears, apples, plums, carrots, beans, peas, sweet potatoes, squash, mango, pineapple, asparagus, spinach, papaya, guava, sweet corn, pumpkin, blueberries, blackberries, cherries, strawberries, kiwi, aronia berries, raspberries, zucchini, oranges, and beets.

3. The process of claim 2, wherein the sweet potatoes are selected from the group consisting of Allgold, Apache, Beauregard, Brinkley White, Bunch, Carolina Ruby, Centennial, Cherokee, Continental Red, Cordner, Cordner's Red, Covington variety, Dianne, Garnet, Georgia Jet, Hayman, Hernandez, Jewell, Porto Rico and White Delight sweet potatoes, or any combination thereof.

4. The process of any one of claims 2-3, wherein the sweet potatoes are peeled IQF sweet potatoes.

5. The process of claim 4, wherein the peeled IQF sweet potatoes are unblanched.

6. The process of claim 5, wherein the unblanched peeled IQF sweet potatoes are diced prior to the cold extraction.

7. The process of claim 1, wherein the heating is not required prior to step (d).

8. The process of claim 1, wherein the heating is sufficient to sequentially activate and then inactivate endogenous enzymatic activity.

9. The process of claim 1, wherein the refining and/or finishing is selected from the group consisting of centrifuging, clarifying, decanting, packing, drying, bottling and canning, or any combination thereof.

10. The process of claim 1, further comprising the absence of any exogenous and/or non-native enzymes.

11. The process of claim 10, wherein the exogenous and/or non-native enzymes comprise one or more recombinant amylase enzymes or reconstituted native amylase enzymes, or both.

12. The process of any one of claims 1-11, wherein starch is converted to sugar by enzymatic catalysis from native enzymes.

13. The process of claim 12, wherein the native enzymes comprise one or more amylase enzymes.

14. The process of claim 1, wherein the one or more fruit and/or vegetable ingredients are peeled prior to the cold extraction.

15. The process of claim 14, wherein the peeling is steam peeling, abrasive peeling or lye peeling, or any combination thereof.

16. The process of any one or claims 1-15, wherein the peeling, cold extraction or cold deaeration steps, or any combination thereof, eliminate any detectable polyphenol oxidase activity.

17. The process of claim 16, wherein the puree is not discolored due to the polyphenol oxidase activity.

18. The process of claim 1 further comprising the step of hot deaeration refinement.

19. The process of claim 1, wherein the one or more fruit and/or vegetable ingredients are added to an extractor at defined recipe ratios.

20. The process of claim 1, wherein the one or more fruit and/or vegetable ingredients are added to an extractor at one or more separate infeed ports.

21. The process of claim 1, wherein the one or more fruit and/or vegetable ingredients are raw and/or frozen.

22. The process of any one of claims 1-21, wherein the one or more fruit and/or vegetable ingredients are diced, chunked, chopped, turbo chopped, crushed, raw, extruded, cut, mashed, pureed, or blended, or any combination thereof, prior to the cold extraction.

23. The process of claim 1, wherein the one or more fruit and/or vegetable ingredients are partially or completely thawed prior to or during the cold extraction.

24. The process of claim 1, wherein one or more screw loader cells meter the one or more fruit and/or vegetable ingredients prior to the cold extraction.

25. The process of claim 1, wherein the one or more fruit and/or vegetable ingredients are blended into a single puree.

26. The process of claim 1, wherein water, ascorbic acid and citric acid are not added to the one or more fruit and/or vegetable ingredients.

27. The process of claim 1, wherein water, ascorbic acid and citric acid are not added to the puree.

28. The process of claim 1, wherein pulp is separated from an ingredient waste stream.

29. The process of claim 1, wherein the final puree is an all-natural baby food puree.

30. A recipe management system for making a sweet potato puree, comprising:
(a) drums and/or totes of unblanched individually quick-frozen (IQF) sweet potatoes;
(b) an extraction device capable of cold extraction, wherein the sweet potatoes are subjected to the cold extraction;
(c) a deaeration device capable of cold deaeration, wherein the sweet potatoes are subjected to the cold deaeration immediately after the cold extraction;
(d) a thermal processing compartment for sequentially activating and inhibiting enzymatic catalysis within the deaerated puree; and
(e) refinement or finishing of the sweet potatoes to produce the sweet potato puree.

31. The system of claim 30, wherein the sweet potatoes are inspected, peeled and/or sorted prior to the cold extraction.

32. The system of claim 30, wherein the cold extraction comprises thermal pulsing of the sweet potatoes.

33. The system of claim 30, wherein the sweet potatoes are peeled and diced prior to the cold extraction.

34. The system of claim 30, wherein heating is not required other than for enzymatic activation and inactivation after the cold deaeration step.

35. The system of claim 30, wherein the refinement or finishing is selected from the group consisting of centrifuging, clarifying, decanting, packing, drying, bottling and canning, or any combination thereof.

36. The system of claim 30, further comprising the absence of any exogenous and/or non-native enzymes.

37. The system of claim 36, wherein the exogenous and/or non-native enzymes comprise amylase enzymes.

38. The system of any one of claims 30-37, wherein starch is converted to sugar by enzymatic catalysis from native enzymes.

39. The system of claim 38, wherein the native enzymes comprise one or more amylase enzymes.

40. The system of claim 30, wherein the sweet potatoes are selected from the group consisting of Allgold, Apache, Beauregard, Brinkley White, Bunch, Carolina Ruby, Centennial, Cherokee, Continental Red, Cordner, Cordner's Red, Covington variety, Dianne, Garnet, Georgia Jet, Hayman, Hernandez, Jewell, Porto Rico and White Delight sweet potatoes, or any combination thereof.

41. The system of claim 31, wherein the peeling is steam peeling, abrasive peeling or lye peeling, or any combination thereof.

42. The system of any one or claims 30-41, wherein the peeling, cold extraction or cold deaeration steps, or any combination thereof, eliminate any detectable polyphenol oxidase activity.

43. The system of claim 42, wherein the puree is not discolored due to the polyphenol oxidase activity.

44. The system of claim 30 further comprising the step of hot deaeration refinement.

45. The system of claim 30, wherein the sweet potatoes are raw and/or frozen.

46. The system of any one of claims 30-45, wherein the sweet potatoes are diced, chunked, chopped, turbo chopped, crushed, raw, extruded, cut, mashed, pureed, or blended, or any combination thereof, prior to the cold extraction.

47. The system of claim 30, wherein the sweet potatoes are partially or completely thawed prior to the cold extraction.

48. The system of claim 30, wherein one or more screw loader cells meter the sweet potatoes prior to the cold extraction.

49. The system of claim 30, wherein the sweet potatoes are blended into a single puree.

50. The system of claim 30, wherein water, ascorbic acid and citric acid are not added to the sweet potatoes.

51. The system of claim 30, wherein pulp is separated from an ingredient waste stream.

52. The system of claim 30, wherein the final product is an all-natural baby food puree.
